(19) United States
(12) Patent Application Publication
(10) Pub. No.: US 2005/0118559 A1
(43) Pub. Date: Jun. 2, 2005

(54) Posteinstein-bohr definitive end and development of new physics with consequences as superaccelerators and direct electricity transformation into light

(76) Inventor: Yuly Zagyansky, Paris (FR)

Correspondence Address: Y Zagyansky, Entralde, 22 rue Ste Marthe, Paris, 75010, FR

(21) Appl. No.: 10/508,967

(22) PCT Filed: Jul. 10, 2003
(86) PCT No.: PCT/IB03/03315

(30) Foreign Application Priority Data
Jul. 19, 2002 (WO) PCT/FR02/02583

(51) Int. Cl. G09B 23/00

(52) U.S. Cl. 434/284

(57) ABSTRACT

After spectacular End of classical genial Einstein-Bohr Physics (PCT/IB00/00843, Exemplary Search: “PCT Gazette” April 2001), this development of New Physics (combined PCTIFR0211308; /2583; 12709) crushes definitively ridiculous Construction of Humanity Impass for centuries (including essential of consecutive Modern Physics), making feasibility of fantastical applications too evident: apriori agreement about synchronism of distanced observers, ridiculous trick of Schrödinger equation, quantum spin of separated particles, special “law” of symmetry violation, famous quarks are examples of Impass falseness. Oppositely, developing network of New Physics is perfect. Nature of electric and gravitational fields is definitively confirmed with conducting electronic and muonic neutrinos (nu) and antineutrino (anti-nu) with frequent periodic “trains” of particle transformations. Contrary to 2nd Thermodynamic law, all radiation does not leave Universe, because of complete reflections from borders, behind which there is no nu and anti-nu. At periodic Universe contractions, this concentrated radiation makes Explosions (Big Bangs). “Gravitation lenses” are due to elevated nu and anti-nu concentrations near colossal masses. Galaxies with disks (and spirals) are created by luminous exploded matter, seized by Black Holes. Overlight speeds of (charged) cosmic “rays” guarantee almost complete passage through Sun and Moon, without interaction with electro-magnetic fields of matter. Radioactivity is due to cause of knocking by such “rays” (protectable, changeable). Big Bang condition imitations permit to create titanic stable temperatures. Increase of forces and speeds of directing electric and magnetic fileds in accelerators (with help of nu and anti-nu beams, also developed) produces particles with colossal overlight speeds. Such superaccelerators produce radiation shorter than gamma, that could produce very frequent electric current, that could produce directly electromagnetic waves (direct visible light too). Destruction (in any depth!) of targets can be done with special combination of such beams. Correct falseness proofs of Michelson and of short pulses application in time-resolved spectroscopy.

### TECHNICAL FIELD OF INVENTION

Invention concerns the definitive (powerfully proved) end of Einstein-Bohr Physics and of the important part of consecutive modern world physics (with numerous Nobel Prizes) developed later, that is done here with help of Author's developed New Physics of matter (with help of Cosmic Nuclear “Laboratory” numerous data) with its applications as titanic superaccelerators (producing particles with velocity values equal to several speeds of light), destruction of targets even through Earth with help of penetrating neutrino and antineutrino beams and direct transformation of the electricity into light (efficiency ˜100%!).

The present Application is the development (simply) of this new titanic too perspective domain after ending of the impass of the World Physics for 100 years (PCT/IB00/00843, WO 00/52989, Exemplary Search Report in “PCT Gazette” April 2001). It is the natural exact combination (with ˜the same claims!) of my common retired Applications PCT/FR02/01308, PCT/FR02/02583 and /02709.

### SUMMARY

New Basic Physics (itself!) propagates too rapidly and surely after Proven End of Einstein-Bohr (WO 99/56288, WO 00/52989. Exemplary Search Report for PCT/IB00/00843: PCT Gazette April 2001), because it is perfectly correct, crushing impass for Humanity for centuries! But Einstein-Bohr Physics with (based on it) Modern Physics (established by genii from genii) became so epochal and classical, that now I had to reveal directly here their (even) ridiculous character (after profound realization) wherein, as result, the functioning, feasibility of these even fantastical inventions became too evident! For instance, the most basic “automatic” discontinuity of atomic orbits. (from “wave” equation) established from Nobel Schrödinger equation is very simple and clear ridiculous trick of introduction of a number dependences between orbit length and energy, justly making the energy AS discrete. Also quantum spin of separated particles (with Fermi-Dirac and Bose-Einstein statistics), violation of symmetry or famous quarks (basic structure of matter) are ridiculous nonsenses too, that changes profoundly all Sophisticated Technique today! Titanic real nature of electric and gravitational fields is definively confirmed with neutrinos and antineutrinos (electronic and muonic) as conductors and with very often periodic “trains” of particles transformations. Contrary to 2nd Law of Thermodynamics!, all radiation of all electromagnetic spectra do not leave Universe and is collected since Big Bang, that takes place due to multiple complete reflections from Universe borders, behind which there is no neutrinos. “Gravitational lenses” are due to elevated concentrations of neutrino near colossal masses. Big Bang is sole explosion due to such concentrated light. Galaxies with disks are created by luminous exploded matter seized by Black Holes. Spiral arms are due to opposite currents with dense dark matter. Successive Big Bangs are different. Cause of fantastical passage of almost all charged! comic “rays” through Sun and Moon is their overlight speeds resulting in absence of mutual electro-magnetic interactions, except ultraminority of “rays”, that knocks small nuclei directly and radioactivity process is due to such knockings (but it is not spontaneous) that can be practically changed with protection. Such Big Bang conditions imitation with decreasing volume of radiation (with elimination of exterior neutrinos and antineutrinos) permits to create titanic stable temperatures. Increasing of electric and magnetic field's forces and speeds in substance could be done with help of beams of neutrinos (electronic and muonic). Increasing of forces and speeds of directing electric and magnetic fields in accelerators permits to accelerate particles until highest overlight speeds, that moreover will open new field of new titanic forces that cohere particles themselves! The most effective beams of neutrinos and antineutrinos after reaction of well focusable charged electrons and positrons are developed. Such superaccelerators could produce coherent and polarized radiation with waves shorter than the γ. Such waves could produce corresponding very frequent electric currents that could be used again to produce directly electromagnetic waves (direct visible light with ˜100% efficiency included). Crossing of neutrino (electronic) beams with particle “rays” with overlight velocities (omnipenetrating both) permit the crusing of target matter (and analogous muonic neutrino beams increase gravitation for production of light particles). Correct serious proofs of falseness of Michelson Nobel experiment (that itself crushes Theory of Relativity) and of erroneous Application of short pulses (§5) in spread time-resolved spectroscopy are presented too.

§1. Previous General Art as Directly Erroneous. Revolution of Revolutions.

The end of whole tree of Physics of Einstein-Bohr was shown with clear proven cuttings of its stem near the root wherein the New subatomic Physics was constructed with subsequent numerous deductions, confirmed (always with convergings) with many done experiments (PCT/IB00/00843 with Rerfs.). But previous Science, established by geniuses of geniuses, became so classical, so epochal (and it was never seen before that the whole classical science, studied by students could be eliminated, moreover by one sole person), that I must prove again the functioning and feasibility of previous and THESE inventions (that are the evident whole) by direct annihilating of Einstein-Bohr Physics and following modern Physics, based on it.

About Functioning and Feasibility.

“Discusssing again the foundations of Quantum Mechanics after these giants was pretentious, useless and maybe even bad taste” (Prof. F. Laloë. Ecole Normal Supérieure [1, pp. 655-701]). Evidently, the annihilation of these foundations is “a little” more gigantic and demans clear principal uncorrectnesses (that was impossible in spite of efforts) or corresponding respect of such work. So in spite of already certainly proven (and confirmed) end of Einstein-Bohr Physics, I MUST DIRECTLY (On the most basic form) reveal unreal alembicated character of this VERY ESTIMATED yet Physics, covered in thousands of test-books and studied by millions of schoolboys and students, understandable even for them (as basic Newton's laws). Consequently the functioning, feasibility of these super-revolutionary (AGAINST ALL!, against Classics!, being even as VERY “bad taste”!) Inventions must become too evident!

### INTRODUCTION

By inductive way of classical scientific methods with a number of consecutive deductions with numerous converging (without exception!) experimental confirmations [accepted by all and for all de facto too, according to exemplary obliging (yet and for all) International Search Report], I have proven!!!, that the principles of Physics of Einstein-Bohr are false. But in spite of a number of mentioned different original and consecutive confirming developed proofs, the most essential knockout could be clearly proven already only with two DETERMINANT proofs [2-4].

FIRST ONE. The generations of genial Physicists of XIX and XX century (as Maxwell and Lorentz, Einstein and Michelson, Fermi and Rutherford) were trying to understand how the intuitive nonsense was possible to measure: why relative speed between Earth and light is the same in any direction of Earth movement. It is unimaginable normally. So everyone among Giants was trying to find the error in such ridiculous famous Michelson Nobel experiment. The detailed articles, made even by great interference specialists, contained a lot of possible Michelson errors. It was point of departure of famous Secretary of American Physicists D. Muller (even visited by Einstein and Lorentz to press him), who was doubting Michelson during 30 years!! But none of these critics was correct! And during century, nobody among such extra-giants did not even suggest that with change of site of the observation due to interference shift, the optical path difference between parallel and perpendicular beams could change. In the very clear precise physico-mathematical calculations, I showed [3,4], that for Iₒβ² (Iₒ is “shoulder” length and β is ratio between Earth and light speed values) shift of observation there is justly Iₒβ² (the same order) additional compensating difference between paths of these beams. And consequently at half of wavelength shift of the observation, the similar compensation shift will correspond to path differences! So the negative result was programmed in all too numerous Michelson-like experiments. Evidently, SURELY proven falseness of this experiment destroys ALREADY the most important postulate of Einstein's Theory of Relativity and all this fantastical imaginative Theory. Moreover, already obviously, the Cosmic “Rays” (protons in majority) have the values of velocities higher than those of light [3], because they pass almost without any weakening even through the objects as charged titanic Sun and Moon (wherein charged particles with close to light velocity value are stopped rapidly even in water) [3]. Obviously, because of too great speed, they do not interact with atomic charges fields, having the value of interaction speed close to that of light, that explains also the radioactivity cause as the random direct knocking by high speed cosmic rays, (of course) with different sensitivity of different isotopes to such knockings [3].

SECOND ONE. I discovered New Force due to ONLY relative movement of charges (as between nucleus and electron), that also was not even suggested by any Great Genius of Physics family of XXth century (Bohr and Einstein, Schrödinger and De Brogli, Planck and Zommerfeld). Existence of this force is obviously definitively proven because finally all charges move with the moving Earth. Moreover, I proved (with help of Universal Le Chatelier Principle) that the direction of this force is “opposite to the momentary movement” at oscillation (in electric field) [2, p. 3] and, naturally that the creation of energy of the electromagnetic field must take place during the work that can take place only with certain presence of opposite equal force [2, p. 3], that was elementary missed by all world science beginning with Great Maxwell and Faraday! Again, well known cooling of matter with radiation (as that of Earth for Cosmos at night) obviously takes place due to such force, directed against vibrational atomic or molecular heat movement of matter [5]. Such too evident presence of this New Force in atom [due to relative movement of nucleus and electron(s)] CHANGES already all basic atomic physics, determining itself the electron orbits as discrete without wrong artificial Bohr postulates.

And now, knowing clearly that this best modern Physics of XXth century is wrong already in its bases, let us see how such apriori wrong complex architecture must be ridiculous, however being chef-d'oeuvre of Humanity for 100 years among Geniuses.

1). General Nonsense of Theory of Relativity.

Justly sole Michelson WRONG experiment made already principally Theory of Relativity. “Whatever might be their nature, space and time must be so constituted as to make the speed of light absolutely the same in all directions and absolutely independent of the motion of the person who measures it . . . This (Theory of Relativity) principle is A RESOUNDING affirmation that Michelson-Morley experiment was correct” [6]. “This principle by itself, without anything else, already guaranteed that the edifice of physical laws built on Einstein's foundations would differ profoundly from that of Newton” [6]. Only from unbelievable independence of relative speed of Earth (Observer) with light (parallel and perpendicular to light movement) (that is wrong de facto [2-4]), Einstein postulated that time is not the same in different space points even if synchonize the watches in the same point and to distance these synchornized watches far away. It is already unimaginable for our feeling. Let two Observers agree in forward to produce the same event at 12 h (one here, another at Moon) with synchronized watches. (So Moon's Observer does not need the signal from Earth for this event!). The event will take place at 12 h according to Moon's Observer watch, independently if this watch will arrive to Earth or not. It is already simple nonsense of Einstein's Theory. Moreover, why it was not possible to synchronize the events (without previous agreement or prepared electronics) by sound? And consequently all Physics would be with other equations!. Only because there was no experiment (Michelson's like) with constant velocity of sound for any observer. But why? What is nature of light privilege for mechanics of movement? And now, when we know about the absence of the light propagation In space without neutrinos (as between Universes), it became already ridiculous! There was no natural explanation! It was like this only because of wrong Michelson's experiment, “naturally”!

Let imagine, another absurd! During Sun eclipse, Observer moves from Earth to Moon with V value of speed [justly less than c value reversibly to ratio between distances Earth-Moon and Sun-Moon (B value)] (distance Sun-Earth is A). According to Einstein (and Michelson), the time for arrival of light (that will meet Earth-Moon Traveller) is equal to A/c. And the time for the same light for simple arrival from Sun to Moon is equal already to B/c. At the same point of Moon. It is Einstein's nonsense again according even to Einstein theory itself.

Moreover, the speed value equal to 3 values of that of light could be obtained in the cable with help of electricity pulsions [7]. With increasing the cable length, such velocity could be used as sending of the information with superlight speed. There is no obligatiory contre-objection here (not like that with impossibility of ancient type of perpetual motion), because of quite different nature of Einstein postulate: so any road has no “to lead to Rome”.

Very recent attempts to check the isotropy of light propagation and invariability of its speed with improving accuracy in 3 times, with finally again Doppeler-effect using as basis (shown clearly to be principally apriori wrong [2]) did not change the general falseness of century [8,9]. Of course, in synchronizing (as written above) the watches (according to proven by me end of Einstein Theory and Michelson's “SURE” experiment, too much checked [2,4]), one should obtain the simple clear data with too perfect addition and subtraction between speed values of light and measuring Observer (at their different relative movements). It will simply definitively annihilate any suspicion even of the most subjective men. And we see already, that even with such idea, they found (although) something against Einstein [10]. However, without global clear profound basic denying of Einstein (and Michelson) Theory, these measurements must be with big mistakes that has already led to the creation of apriori complicating theory (generally wrong as already “partial” “ether drift” that was explained with wrong theory of Lorentz-FitzGerald contraction [2, p. 31]) with only very strange wrong “local-ether model”, wherein Earth's orbital motion has no influence on relative speed with light (certainly uncorrect), but Earth's rotational one has (generally, this is certainly wrong too) [10]. But last direction indicates already the denying of Einstein Architecture, confirming me [2,4]. The 1st part of these data (contradicting to 2nd part, which are certainly wrong too) [10] must be certain great experimental errors due to complications with real direction of Absolute Earth movement due to too! elevated mutual movements (of order of 600 km/sec!!) of Galaxy Clusters (with us) and “Great Attractor” [2,11] with also the direction of expansion of all Our Universe parts due to Big-Bang explosion! With real scientific basis, the precise measurements (with determination of all exact absolute movements [4]) within all 4π stereo-radians must be done.

All this shows simply Theory of Relativity only as abstract imagination, that, now, does not have ni any experimental basis ni any good physical sense, except primitive nonsenses as shown above.

2). Quantum Mechanics as Naive, Unbelievable Construction to Save Wrong Beginnings.

a). Quanta as Wrong Departure for Evident Century Impass.

But where is the origin of impass of Quanta? Taking again into consideration the beginnings of Planck era, one can see the clear simplicity of their errors. Very naturally, the matter of “black body” must be excited only at frequences of resonance of its oscillators. So Rayleigh-Jeans suggestion about collection of oscillators of all possible wavelengths is primitively wrong from classical point of view too, and “ultraviolet catastrophe” due to infinitely large quantity of energy, radiated by “black body” (that cannot be absorbed) cannot be even discussed apriori. Evidently, the solid carcass of “black body” (lattice) has the restricted quantity of types of oscillators, having the classical resonance only at particular wavelenghts. And the famous “revolutionary” calculations of genial Max Planck (who suggested that discrete energies of electromagnetic oscillator of frequency ν are Integer multiples of hν) or of Albert Einstein (that each atom oscillates about its equilibrium position with single [justly classically] frequency ν, that justly corresponds to resonance of lattice!) gave already satisfactory results, but quanta existence is not followed from them. Evidently, at photoelectric effect, the free electrons could be oscillated at a number of continuing frequences. And from quite different positions, the energy of light is proportional to its amplitude classically. It is only exceptionally, in the case of radiation from the atom, the amplitude of radiation is proportional to its frequency because this amplitude (always as square proportional to energy) is proportional to wave's frequency only in this case [2]. (According to below invention, one can have the amplitudes of electro-magnetic waves independent on frequence).

Also, very easily and clearly, the “classical” “surely convincing” quantum experiments as Compton's (simple oscillating of electrons of the matter by radiation with special dissipation of energy due to specially taken paraffin block) or unexisting “diffraction” of light (that takes place due to only Huygens reradiation by obligatory! metallic slit) showed already the simple natural classical interpretation [2]. Moreover, the interpretation of experiment of Davisson-Germer is unimaginable unpardonable nonsense. The mysterios De Brogli's wave is “wave, associated with corpuscle as the representation of probability, giving, by its intensity (amplitude square), the probability of corpuscle localization” [12, p. 8]. So it is even unimaginable, how such different intensities (but not different phases for amplitudes!: “max with max” or “max with min”) can make the interference! Of course, it is simple secodary radiation of nickel crystal with coherent light, making the different differences of paths as with classical slit. Very recent experiments justly confirm this interpretation [13]. There is no already “diffraction” in the case of electrons that fall on the intense, obligatory polarized, light beam but without presence of matter for secondary (Huygens) radiation. But there is the deviation (repulsing) of the electron beam due to the Intensive creation of temporary (at stationary beam passing) negative charges, confirming revolutionary temporary transformations: neutrino+light—>electron [2]. Moreover, the reality of light propagation with help of transformation of real particle (that makes, even temporary, the real charges) is obvious: the electromagnetic transformations in empty space looks now as unexisting, as science-fiction (against Faraday and Maxwell and accepted by Physicist World during century) because of absence of neutrinos and antineutrinos in space between Universes, wherein the light cannot pass [2,3].

It is very simple demonstration. But yet accepted quantum of light (so called “photon”) looks like too simple nonsense taking (for coherent light from the same source) the parts of this source with different directions (how many: 2, 3 or 10? with how many “minimal” stereo-radians?), one can have the infinite number of the coherent quanta from the same radiation: NONSENSE! In evident confirmation: radiation due to the same vibrations of the same electron in radio-antenna (classical radio waves with “weak” energy, that is also falseness and must depend on square of amplitude value of the electron vibration movement as for any wave [2]) takes place in all “horizontal” directions (as for my new developed process for atomic radiation [2]). How many “photon” quanta here?! It is already unbelievable. Moreover, using (according to this invention) the electromagnetic radiation with small amplitude (and with strong frequence), one can again almost avoid the influence of perturbation (so called Heizenberg principle) due to the measuring light during observation.

Moreover, the reality of the New discovered Force can be confirmed again and again! The scattering of the negative electrons on positive protons (instead of simple attraction) [14] can take place only due to such repulsing force. Very convincing cooling of radiating matter (as during Earth cooling at night in re-radiating the sun light [5]) cannot take place without such force directed against heating movement during the oscillations in creating the energy of electromagnetic field [2, p. 3]. IT IS THE 1ST EXAMPLE OF DIRECT WORK! PRODUCTION FROM THE HEAT!!! Revolution Against Fundamental! Principles of Contemporary Thermodynamics!.

Moreover, it is pure falseness when “Quantum Mechanics people” claim “that exact counerpart of information which experiment has given us of atomic world” is adopted in quantum mechanics [15, p. IX]. One can see already a number of certainly unresolved experimental contradictions of such Quantum Theory, as absence of (corresponding to “Quantum Theory”) numerous spectral lines (in H or He), corresponding to the quantum numbers (“orbit ellipticity”) or the presence of magnetic quantum numbers in atom yet in the absence of the exterior magnetic field against principle of Pauli [2]. But moreover, the revolting famous contradiction against good sense is too obvious in the case of I=0 (famous s-orbit with orbital momentum equal to zero?, that is also ununderstandable at all, except the falling on nucleus). Wherein the probability presence of electron on nucleus is clearly maximal, that never happen. Moreover, they make very important treatment of experimental data with help of theoretical angular and spin momenta for so claimed “exact counterpart which experiment has given for us” [16]. And justly here there is a lot of un explained (and unexplainable) arbitrarinesses!

At the light atom, they take the resulting atomic momentum with help of coupling “LS”. It means firstly that the angular momenta of different electrons (I) are coupled and analogically, the spin momenta (s) too. And then there is the coupling of resting L and S vectors. But in atoms with many electrons, they couple firstly the I and s momenta of each electron and then all resulting momenta of all electrons [(j,j) coupling]. I did not really understand (being yet student) even these rules because of sole force (sole interaction of moving Whole electric charges=magnetic interactions) of Lorentz (finally) for interaction of moving charges. THERE IS NO TWO FORCES OF LORENTZ, is not it! The movement of the electron is always whole movement that does not depend on theoretically made (by man) projections (that naturally does not disturb the radiations). In reality, the liberty of arbitrariness for adjusting to ANY experimental data is flagrant. It is uncomprehensible why there are so extreme couplings (only two extremes), but not “smooth” partial mixture couplings, depending on the closeness of particular electrons. So by such way, they could “explain” the VERY large family of data (almost any?) without serious problems, claiming the correctness of their bases.

Moreover, this alembicated “Quantum” Mechanics did not resolve at all (and could not!) the mechanism of light production. “No explanation was offered for the process by which a quantum was emitted and absorbed during the course of which the electron had to jump from one discrete orbit to another” [15, p. 75]. This resolved by me process (in difference with nowdays “Classics”) perfectly fits into general structure of New Revolutionary Physics [2, p. 10,3,4], free from such numerous Achilles' heels. Wherein consequently even the bases of whole Discipline “Electrodynamics” are false with a number of direct important falseness as the radiation (that does not take place) at simple decelerating of the electron [2].

Moreover, this process clearly explains another accepted contradiction of Quantum Mechanics: “Why electron stops radiation when it reaches the normal radius of the atom” [15, p. 74]. Evidently, this normal orbit is the most unperturbable (without “clearance”), that does not permit ANY NEW oscillation [without new excitation (because all were done because of any, even chaotic, vibration and oscillation]. (Wherein there are the oscillations which justly diminish the own energy of the electron In producing the energy of electromagnetic wave). This justly helps to have the strictly determined “quantum” orbit with well determined, “corrected” (de facto) rₒ (radius) and Vₒ (tangential speed) [2].

It must be not occasional that at such unrestricted science, even “nine! formulations of quantum mechanics”, in spite of their “drastic”!!! differences “in mathematical and conceptional view”, made (“each”) “identical predictions for all (always?) experimental results” [17]. And how many other formulations with “drastic differences”!!! And it is not funny! Even general conception of “quantum mechanics people” (E. Schrodinger) is fluent. They do take however apriori appoximative interpretation of quantum mechanics and claim finally that interpretation of quantum mechanics does not have the sense. “The usual interpretation of previous formalism is the “purely probabilist” interpretation, it means it forbids apriori to search outside of the probability laws . . . and forbids to imagine the hidden reality on which the probability laws were valuble . . . this affirmation appears to be very contestable . . . because electrons, atoms or atomic nuclei are never observable directly (neither)” (De Brogli [12, p. 19]).

b). Bohr: Rotating Electron Due to Only Coulomb Forces With Artificial Quantification for Permitted Orbits.

To explain the discrete spectra, in knowing only the electrostatic forces, N. Bohr introduced his planetary model, wherein the electron rotated due to the classical electrostatic forces. But the artificial new NONCLASSICAL quantization of orbits was introduced to explain the presence of discrete spectra. Uncertainty Principle of Heisenberg developed this artificial (from Classical point of view) Bohr postulate for special atomic scale wherein it “represents an absolute and final limitation on our ability to define the state of things by means of measurements” [15, p. 85]. “The perturbations, introduced by measurement which are imposible to eliminate, prevent us in general from predicting precisely the result which it will produce and allow only statistical predictions” (De Brogli in [15, p. IX]). And because of such, rather atomic, specificity, De Brogli introduced his duality (but attention: very special, unusual one): the particle is in “each moment in one point of wave (OF PROBABILITY), but we do not know what is the point” [12, p. 20]. So for Classical law of Newton and Coulomn interactions, because of very strange discrete optical spectra, the Uncertainty was finally intuitively introduced about electron presence in space, that could resemble already the wave too (as duality), but only in this (probability) sense. However these were yet rudimentary claims but not yet developed theory.

c). Definitive End of Quantum Mechanics Also by Understanding of Essential of Ridiculous Trick of Certain Misleading of Schrödinger Equation.

The Schrödinger advance had crucial importance for development of Quantum Theory as serious science and consequently for its today crushing (in this work). It is a little funny, but Schrödinger made his famous equation with quite different purpose, than it was interpreted later. In reality, he considered the electron as the spread (in space) electron density, that “would be comparable to a wave packet which moves with group velocity” [18, p. 47]. Such thesis was already denied by great Lorentz. “But a wave packet can never stay together and remain confined to a small volume in the long run” [18, p. 47], that was proven with 12 pages of Lorentz's calculations with which Schrödinger was agree! So Schrödinger corrected immediately afterwards: “One interprets the determined distribution of ψ (wave function) values in configuration space (space of variables q_{K}-coordinates) like the continuing distribution of electricity (and the density of electric current) in the real space” [19, p. XXI] or “one interprets the model of ψ as electrical or electromagnetic source that products the electromagnetic field” [19, p. IX]. Really, this last correction does not change much, it only makes the picture less determined. The situation was already not very convinsible.

The beginning idea of Schrödinger was in reality only to experiment what will happen if to make the analogy with transformation of the geometric optical lines to the real light rays becoming already as wave at very small dimensions. So he wanted to abandon notion of trajectory of system (at small sizes), wherein “the fundamental equations” of Mechanics (for electron) “must be replaced by the sole equation of waves in configuration space” [19, p. XIX]. Only to have the similar results, he is making merely the experimental adjustings, so he confesses that “effectively, it is possible that these methods will not produce new results and as whole it will be only theory calculated identically on ordinary theory of quanta” [19, p. 13]. Moreover, Schrödinger confesses also that “this manner to formulate the problem is not unic” [19]. So Schrödinger wanted (by his chance of experimentator) that “rules of quantification (of Bohr) could be replaced by other condition, wherein there is no question of “integer numbers”. These integer numbers are introduced by the same natural manner as the knots of the vibrating string” [19, p. 1]. And he made “the magic” with such “natural manner” “of vibrating string” for 80 years of “Quantum” Mechanics and nobody of Supergeniuses have found the trick of circus here.

One can see the below disclosing of the “mystery”, annihilating this “Quantum” Mechanics after 80 years. But the appearance of discrete permitted orbits takes place not because of above knots of string themselves! In making the string (as the orbital circle too) longer and longer, one will have the “wave-length” between knots longer and longer each time and each such continuing orbit must be acceptable! Consequently, itself, it does not give the discontinuity that proves already the Schrödinger's error. But Schrödinger wants that “own periods of the wavefunction will be those of elliptic orbits of Bohr atom” [19, p. VIII] so for this, he wants “to obtain effective numerical agreement in diving the value h/2π for constant K” [19, p. 21] (or similarly, for instance, TOO elementary and directly [20, p. 7]). So Schrödinger introduces in reality also the relation between λ (wavelength of electron spreading firstly) and p (quantity of movement) (according to Bohr and finally to De Brogli), that clearly means between λ and total energy too, it means between length of orbit and energy, restricting drastically the admissible energies again, that justly makes the “mysterious” Quantification finally. In simplifying: it is like to add 2nd equation to 1st equation with 2 variables x and y, wherein as result there will be sole solution finally! It is too elementary! So Schrödinger equation is the same as postulates of Bohr (or following De Brogli) and the quantic specificity of microworld (automatic moreover!) does not present here. However, until now there is “hundreds of contributors and thousands of papers to develop this . . . the most spectacular scientific development” (Schrödinger's equation) [21], that underlines the magic sense even of this sole advance: destroyment of this army! of workers for nonsense!

And this is the case that the same discontinuity of the orbits (but at macrosystem), one can have “if to resolve the relativist Kepler's problem wherein after previous indications, one finds that the same partial quantic numbers (azimutal quantum and radial quantum) must be obligatory half-integer” (Schrodinger in [19, p. 13]). That is certainly not the case in situ in difference with atoms because of the presence (in last case) of New unknown Force [1,2]. That justly makes the equilibre (that makes discontinuity).

Moreover, in taking the same Schrödinger system with planetary model but with large macrocharges and masses (instead of those of electons and nuclei), one must have also discrete system of MACROorbits (according to Schrödinger). This experiment is possible easily to do too. But it will confirm only the presence of discrete orbits (In this case!) due to New opposite Force [2]!, according to other equations!! and calculations [1,2], but not according to the same Quantum Theory, but at Macroscale.

d). For Such Already “Solid” Quantum Mechanics, Based de Facto on Real Schrodinger's Trick, “Quantum Mechanics People” Imagine Words of “Royal Probability” (Never Seen Before) Who Makes to Occur Events.

“In all collision experiments, particles are observed to follow well defined trajectories which remain perfectly localized going in some direction” and this had to stimulate the introduction of the probabilistic interpretation of the wavefunction (wave of probability), but with particle behaving as a whole [1, p. 658]. So in the next act of this Construction, imagining Geniuses of XXth, in taking the “general” (§2c) Schrödinger equation, throw away his unsupportable wave packet of electron density (against resting Schrödinger opinion but who however took Nobel Price with their interpretation).

One simple analogy of Max Born was sufficient for New Saving Air for “Construction” (apriori wrong) as we could see easily now (§2c) and as it was claimed by Einstein and Schrödinger many years ago however from only general position of the determinism. Born took firstly the become Classical example (see for Instance Superclassic Landau and Lifshitz) from Classical Theoretical Mechanics with rays of α-particles scattered by nuclei with law of diffusion of Rutherford (for case of energy>0 at similarity), wherein the modulus of square of analogous function |ψ|² is proportional to the number of electrons in perpendicular direction in diffused deviated beam. But it will be similar to finding of the probability for one electron to be in this direction [22, p. 134]. And such simplicity of some analogy became the ruling interpretation of (simply!! already tricked in bases) “Quantum” Mechanics with Schrödinger's equation as basis No 1. “Hence the problem of descibing what actually happen in an individual process had not yet been resolved. With interpretation of Born, the Schrödinger wave only treated the mean behavior in statistical ensemble of cases” [15, p. 78]. (“Schrödinger originally proposed that the electron should be thought as a continuous distribution of charge. The density of this charge he assumed was related to the wave amplitude ψ, by the relation, ρ=|ψ|²” [15, p. 77]). So “the behavior of electron cannot be predicted because, determining factors that are important at atomic level have been left out the theory” [15, p. 85]. “The perturbation introduced by measurments which are impossible to eliminate prevent us in general from predicting precisely the result which it will produce and allow only statistical predictions” (De Brogli dans [15, p. IX]). But this, apriori probabilist (although automatic) character of discrete solutions of electron movement in atom takes place due to (as physical cause in real world) perturbing intervention of devices at (only) microworld level (only at microworld level according to Principle of Heisenberg), wherein the discrete solutions is not thruth (§2c). “This principle represents an absolute and final limitation on our ability to define the state of things by means of measurements of any kind that are now possible or that ever will be possible” [22, p. 85].

So with such “quantum” solutions (sure trick in Schrödinger solution), it is not forces (with previous coordinates and speeds) that determines the body behavior but some too formal function of probability and this takes place (in difference with classical physical sense mechanics) because of perturbation by devices for measurements. From above sure proofs against Construction, it must be the nonsense apriori. But concretely. What is wrong about governing (particle movement) Royal Probability? . . . I throw coin. As probability predicts: heads—50%, tails—50%. And now (with exercises I mesure my force: heads—100%. It is the force that governs when the force is known which does it too even when the force “value” is unknown. Again, let fall the ball (in vertical channel) on the centre of vertical thin rod. With similar probabilitiues, the ball could fall at left and right of thin rod. Evidently, in measuring by lens the position (amplified) (as with force “value” with coin) for first falling, I can know (as with coin) (in forward), that it will fall at “right” (for instance). But for instance, reader does not know my lens measurements. So for me, there is no governing probability, but for reader it “ACTS” at the same experiment. It is nonsense even from general position, as Einstein systematically underlined the falseness of Construction: there is no sufficient knowledge about parameters of equation, given in Einstein, Podolsky, Rosen (EPR) theorem [23]. Which was logically developed further in theorems as those of Bell or Bell-Kochen-Specker (BKS), in taking “completely seriously the existence of the EPR elements of reality and introduce them into the mathematics with the notion λ” [24-26; 1, p. 666]. Such mathematical formal λ-like “improvements” (approaching formally to the determinist framework) unfortunately could not predict de facto even direction of any search of the discovered here [2] New Force, making such discrete equilibre. And they were de facto the negative factor, hiding the real unknowing by pseudonecessary mathematical irrealistic constructions for impass of sleeping, lasting more than half century.

Evidently Geniuses of XXth were not overcome after their fantastical savings of apriori wrong (simply false) Bases of Einstein-Bohr Physics with help of very imaginative, too unusual postulates even without good physical sense of Human experience. Behind the fantastical fog of their imaginative unusual nonsenses, they could even ignore the neccesity to answer for too simple question of child: but “why events occur” [1, p. 662], making the absence of such answer as theoretical necessity! “The start of 21st century finds Einstein's 1915 General Theory of Relativity more central for physics than ever before” [27]. And one sees that “the same recurrent ideas are so often rediscovered, they appear again and again sometimes almost identical with years, sometimes remodeled or rephrased with new words, but in fact more or less unchanged”. “It should be emphasized very clearly that until now, no new fact whatsoever (or no new reasoning) has appeared that has made the Copenhagen (Nils Bohr) interpretation obsolete in any sense” [1,28]. This is the impass (but) made by Geniuses, so there is only one “discussion (in 2001) to decide whether or not quantum mechanics in itself is inherently nonlocal have taken place” [1, p. 674]. Although De Brogli stated it yet long time ago: “Majority of them . . . have thought that they could go further and assert that the uncertain and incomplete character of the knowledge that experiment at its present stage gives us about what really happens in microphysics is the result of real indeterminacy of the physical states and their evolution. Such extrapolation does not appear in any way to be justified” [21, p. IX].

And suddenly all such respected “Construction” becomes the terrible Grotesques: “But where exactly is limit between two worlds?” (everyday world and microscopic systems) [1, p. 660]. Justly there is no such border according to “classical” basic Schrödinger equation (in greatly increasing masses and charges of particles, leading to the same discrete solutions—§2c) on one hand. And on another hand the border (too well known) is found de facto already at the atomic periphery, wherein the optic spectra are already continuous. Simply, naturally: justly where the both (opposite equilibrium) forces are smaller and less dependent on radius and there is a less influence of already distanced resting electronic shield according to New Physics [2]. Or other classical position (false) of Copenhagen school, exemplified by Jordan: “Observations not only disturb what has to be measured, they produce it. In measurement of position, the electron is forced to a decision . . . to assure a definite position” [1, p. 660]. But how? Does it decide its personal freedom with presence of indeniable forces (as electric) and their decisive absence (as complete) at the same time? By which kind of “demi” brain (constantly fluid in clear wishes to hide intuitively the clearest errors by genial imaginations)? It sounds as hymn to imaginative fiction. Instead of simple throwing (§2d) of coin with the same (only a little unmeasured) undenyable physical force of thrower to claim choice of “coin” decision. Evidently, space reality of nervous cell circles (network of so called “PKC” vesicle circles), constituting our conscience [28a], makes time of “observer” as different, undetermined principally!

3). Other Evident but Clearly Braking Nonsenses are Still Alive.

It is interesting to note that the examples of fantastical common misleading (almost artificial), contradicting to elementary physics continue dominate the world, contradicting to this developed New Physics. Naturally, justly these simple nonsenses are very easy to remove. For instance, the theory of nowadays acceleration (!?) of Universe is dominating the world science now, in spite of its alchemistical (according to these scientists) character [29]. This theory is based on observing that farest Galaxies are moving quicker and quicker than the others. But too evidently, because they move with higher speeds, their distance from ensemble of gravitational forces (“behind”) increases quicker than that of “interior” Galaxies with stronger decreasing of the decelerating forces. Moreover the explanation of such acceleration with, for instance, the pression of light focused by gravitational lenses is too ridiculous. These gravitational lenses have simply the same nature as light refraction by prism (due to increasing neutrino concentration at strong masses) [3]. So the simple light (although bent) pushes the Gigantic Galaxies with help of real Alchemistry of Middle Ages. Moreover, only the proces of Big Bang, proved by me, as one of the (always) converging proofs of New Physics [2, p. 47, 3] can explain such differences in speeds after Big explosion.

Other example of the fantastical misleading is cosmic “rays” (without light!) with extra high energy, which arrive at Earth in spite of theoretical (GZK) cutoff. Evidently, they arrive from other Universes (confirming strongly discovered nature of electric field with its absence between Universes [2,3]), but World science “explains” it as the arriving from close area (no partcile cutoff consequenly) from unvisible (no light, only particles with enormous energy) source [30]. Happily these areas are, moreover, TOO LARGE (making this explanation more than fantastical) and it is IMPOSSIBLE not to remark the light (with these cosmic “rays”) from close distance. Wherein even much smaller areas, however, are visible even from much stronger distances.

4). Grand Falsenesses of Consecutive Modern Post Einstein-Bohr Physics.

Naturally, the modern post Einstein-Bohr Physics based principally on Einstein-Bohr Physics, has its essential part as falseness. This modern physics does not contradict to this my work, but oppositely its EVIDENT falseness confirms it!

The quarks, basis of bases of the structure of matter (minimal undivisible units of principal constuting matter: protons and neutrons), are the artefacts!! In the majority of cases, their existence is proven with help of unexisting [2] “annihilation” of matter and antimatter, wherein they “rematerialize into quark and antiquark”, that try to separate quickly with increasing the potential energy for creation of other quarks [31 pp. 396-423; 32v.14, pp. 701-706]. Moreover, in this creation (according to famous Einstein's formula) of new matter from vacuum (due to only energy: which one? potential “electrostatic”, electromagnetic? kinetic?. LIKE THIS! “Any energy” into “what god want”.), it is too fantastical and naive to have too different particles from the same energy. What was the law? Science fiction of approved fantasy, that is shown now exactly [2 and here]? Too strangely, these famous quarks were never obtained isolated. The nonsense of even the most important classical case of the transformation of neutron into proton confirms such absurd, named quarks (n->p⁺+e⁻+\overline{ν}_{E}). These particles differ only by d-quark minus u-quark, so their difference cannot be electron plus antineutrino. It is absurd even in the most basic transformation. Quantum Spin of separated particle is pure nonsense. But strictly quantified SPIN angular momentum of any elementary particle is the basis of nuclear and particle Physics! [32, v.13, p. 120]. In cases of the electrons, rotating in the atom, they must have finally the same values of spin and orbital angular movement due to obligatory oscillations with decrease of kinetic enrgy for electromagnetic radiation energy [2] until the state without any perturbing losing oscillations [2] (and above). So in the atom, the electron has the discrete spin angular movement only due to classical physical laws, that it does not have outside of atom as well as any other particle.

Consequently, during any transformation in atom, the subsequent movements of particles will be determined only by laws of conservation of momentum and angular momentum (orbital and spin). So the strange determining special nonclassical “laws” of CP symmetry violation (CP is product, C-charge conjugation, P-parity or coordinate inversion) [33; 32, v.13, pp. 119-122; v.19, pp. 486487; vol.6, pp. 317-320], certainly must have other explanation as, for instance, in the case of β-disintegration (weak interactions). Wherein the orbital rotation of the positron could simply take place in opposite direction in the case of antimatter (anti-⁶⁰Co) clearly explaining correlation between handness and sign of charge (for β-decays of nucleus and antinucleus). As the purest nonsense of crazy unrealistic spin “determination”, the “sure” undeniable!! value of spin of “photon” (so called “boson”: ouside of atom) is the outstanding absurd because the light is not the particle but the purest, too evident, electromagnetic wave (only!) [2].

This fact of the absence of quantum spins of the elementary particles had to lead the scientist to try to skirt this obstacle of the falseness that really culminates in the creation of the Super-symmetry Theory with the diminished difference between bosons and fermions [32; vol.17, 718-720, pp. 69-692; 34, p. 231; 35, 36], that justly was producing the positive results [37]. {Even at such Tenebrae of imagination, wherein “it is almost impossible . . . to find two (evenl: YZ) authors using the same assumptions about various masses and couplings in the supersymmetric theory” [34, p. 201]}! Naturally Higgs particles with bosons W and Z, created during collisions and annihilations with over masses due to energy [31, p. 418; 32, v.13, pp. 119-122; vol.6, pp. 317-320; 38] (according to the famous ARCHI false Einstein's formula [2]) must be the fantastical artefacts.

It must already certainly mean that the mechanism of the Weak Interactions [32, v.6, pp. 317-320; v.13, pp. 119-122] must be apriori false. This is confirmed by certainly quite different nature of the unified [32, vol.19, pp. 486-487] Electromagnetic and Weak interactions (“electroweak” interactions). The cosmic “rays” contain only the nuclei of all elements, (and also electrons and positrons) certainly without atoms [32, v.4, pp. 503-513]. The process of the persistently complete ionization even of all heavy atoms in such “rays” must take place only under very special unknown unique process, that eliminates Electromagnetic interactions (between electrons and nuclei) and does not eliminate Weak interactions (electrons and protons on neutrons and protons [2]). Justly such process must be due to the natural neutrino and antineutrino absence between Universes [2], that justly must eliminate all electrons rotating around the nucleus but not electrons and positrons making weak interactions with neutrons and protons [2]. These completely ionized nuclei (in such cosmic “rays”) could travel through thousands of Universes during milliards of milliards of years!!!

Evidently, after definitive end of Einstein-Bohr Physics [2] (and above), its direct consequences as fantastical Dark Energy and Antigravity [29; 31, p. 34-60] must be specially false with the long new pseudoaccelerating programs (de facto) as “Aha”.

§2. The Most Profound, Definitively Established, Astonishing Nature of Fields (much Farer Than Those of Maxwell and Faraday and Modern Nobel Winners) With Practical Consequences.

1). Precise Confirming Functioning of Electric Fields.

It was shown [2, p. 20] that “there are the transformations waves (very momentary and frequently) of the neutrinos and antineutrinos into the electrons and positrons (repetitively), beginning from the electrons and positrons of permanent electric charges”, that are responsible for electric forces (field). The presence of clouds of virtual “photons” surrounding electrons [39, for instance] confirms such mechanism where “there is no any energy loss during these spherical waves” [2]. The virtual “photons” are also considered as mediators of electomagnetic field [31] even without any serious knowledge in nature of this field. Moreover, with threshold lepton (electron and positron) radiation of nuclei, there is the creation of such virtual “photons” [40-42]. One can compare such above threshold process (having virtual photon and consecutive virtual transformations): with (threshold) virtual transformations of neutrino (ν) and antineutrino (\overline{ν}) into electron (e⁻) and positron (e⁺) in the case of light propagation [2] in difference with strong irradiation of such neutral particles and their real complete transformations into electron and positron. So I can concretize more this correct process [2] in very net clear epochal (firstly correct) process of electric field action. In the case of positive charge, there is the above periodic transformation waves [2], propagating with help of virtual “photons”, that finally repulse (by last temporary positron) another positive charge or attract another negative charge:
++++> +++> +++> +++> +++>+ (it is \overline{ν} [symbol] e⁺!) Such periodic forces are ˜to discrete quantity of such “charge trains”, conducting electric charge action. “−” charges act similarly, but with: ν [symbol] e⁻!. So light! created by “+” or “−” charge oscillations is different in this sense and deviation of electron beam ([13], p. 7) must be opposite in case of “+” light. Formal line force intensities are ˜to intensity of above concrete particle train lines.

2). As Predicted, Gravitation Field is ALSO Conducted by Neutrinos and Antineutrinos (Muonic). Confirming so Unusual Nature of Fields Conducting to These Extrapractical Discoveries.

In manner, analogous to Albert Einstein, I predicted that “gravitational field (the analogous change with distance) must also propagate like the electric field with the spheric waves (logically, the continuous) without the energy loss {as the vacuum fluctuations [40-42]}, where the sole omnipresent (ν and \overline{ν}) must guarantee the similar short distance action of the forces” [2, p. 20]. I only concretize here this correct process.

It is from the neutral pions (π^{O}) (that could be inside of nucleus [43-46], being, justly, accessible to all nucleons), that the gravitational forces commence their action. Justly the accessibility for all nucleons can guarantee the weight proportional to the mass (inertional) of nucleus (to all its nucleons) and form of nucleons closer to disks justly will give such larger access to all nucleons. Naturally, the nucleus must be VERY small (it means well compact), because only extremely seldom cosmic particles (“rays”) (that do not have the electromagnetic interactions, because of speed value more than that of electric field) are stopped by the atomic nuclei of Great too charged Sun (§3,4). Wherein strong nuclear forces exercise their action at very short distances. [32, vol.17, pp. 522-523]. There is strong pion absorbtion in nucleus [44,46]. And as opposite reaction, there is the production of pions (neutral and charged) from nucleus during the nucleon-nucleon collisions (photoproduction) [42,40] or with scattering of leptons (electroproduction) [40-42]. There are a number of transformations between different (neutral and charged) pions [45-47]. But only the π^{O} production can take place coherently [42]. Evidently, for gravitational interactions (that are colossally weaker than charged electromagnetic ones and should not have the interferences with them), the particles must be neutral. Moreover, at threshold pion production, there are the virtual “photon” creations [40-42,47], similar to that at electromagnetic field action (§2).

Let us see the very classical transformations of pions and muons [48]. π⁺ [symbol] μ⁺+ν_{μ} (1) and μ⁺ [symbol] e⁺+\overline{ν}_{μ}+ν_{E} (2). So globally: π⁺ [symbol] e⁺+ν_{E}+ν_{μ}+\overline{ν}_{μ} (3). (Wherein: μ⁺, e⁺, ν_{E}, ν_{μ}, \overline{ν}_{μ}-are muon [positive here], positron, electronic neutrino; muonic neutrino and antineutrino). Simply analogous transformations can be written for negative pion.

{This globalisation of reactions resemble that with neutron [2]. Too classically [48]: n [symbol] p⁺+e⁻+\overline{ν}_{E}+gluon (1′); p⁺ [symbol] e⁺+n^{o} (2′). And globally: n [symbol] n^{o}+e⁻+e⁺+\overline{ν}_{E}+gluon (3′) (wherein n, p, e⁻, e⁺, \overline{ν}_{E}, n^{o}-are neutron, proton, electron, positron, electronic antineutrino, neutro) [2]}.

In the case of the mentioned fitting neutral pion, such transformations are not known. But it is known that there is (as-YZ) two-“photon” emission at π^{O} “annihilation” [49,48;31, pp. 396-424], that does not exist [2]. Knowing that neutral pions is some easier that charged ones [31, pp. 396-424], I can write the analogous transformation: π^{O} [symbol] ν_{E}+ν_{μ}+\overline{ν}_{μ} (3″) or more precisely, it means finally: π^{O} [symbol] ν_{E}+ν_{μs}+\overline{ν}_{μs}+2γ (3′″) (wherein ν_{μs} and \overline{ν}_{μs}-steril, silent muonic neutrino and antineutrino [50,51,34] and 2γ-are 2 emitted “photons”). The following considerations serve for such concluded process. At the final process of π⁺ and μ⁺ decays, there is, justly, the supposed appearance of steril silent heavy (muon) neutrino [52-54;51, p. 394]. Of course, as in the case of analogous action of electric field (§1), the appearance of only virtual “photons”, TOO EVIDENTLY without energy loss (as in the case of LOWER THRESHOLD pion production—see above), must take place during the action of gravitational field.

But justly “the behavior of neutrinos produced in the Earth atmosphere, provides rather convincing evidence of oscillation” of muon! neutrinos into silent muon neutrinos. Moreover, “muon neutrinos are being lost as they transit the Earth” {justly more loss with the trajectory (with angle to the Earth) passing more through Earth} [55] and also [56-58]. These unexplained data (experimental) are the most serious data of last ten years, that received already Nobel Prize. After clear END of crazy Einstein's formula [2] (and above), it is impossible to transform the mass into heavier or lighter one [except unification of particles as in equation (3′) with special forces as special weak or strong nuclear ones]. Moreover, “unfortunately (according to “unhappy” author) in the case of mixing between the three known neutrinos only, there is no observable effects in the standard case of thermal equilibrium” [51, p. 511]. But unfortunately, consecutive essays of explanations of these extremely interesting mysterious Nobel experiments go in the clear sens of impossible (with too important Einstein's end) oscillations between different neutrino flavors [56,57].

Such clear above presence of steril muon neutrinos (in clearest connection with gravitation!), that were theoreticaly predicted from Supersymmetry Theory [§1 (4)] [also 34,51] (as normal particle partners) is favoured by cosmic data (as the constituents of cold and warm dark matter). [51,59,60]. Again the Muonic neutrinos are part of high energy cosmic rays (and Sun radiation) being stable particles [59-61,55-57,30]. It is important that virtual polarized “photon” can produce massive neutrino-antineutrino pair [62]. Such “photon” can be produced justly during “annihilation” of steril muon neutrino-antineutrino [equ. (3′″)] (confirmed in [34, p. 287]). Also in confirming: Muon s-neutrino (silent) may be produced at “annihilations” with μ+μ⁻ colliders [63]. There is “the impossibility to identifying the sole sterile neutrino of the currently favoured 2+2” [64]. The reaction (3′″) can take place after the transformation of neutral pion into its another form, that was justly observed in nucleon-antinucleon “annihilation” [65], confirminng the short lifetime of the neutral pion in the nucleus [40-47].

After such well defined characteristics of gravitational field {in confirming important analogy with electric field action (§1), that is confirmed also by their similar speeds [66]}, I present here the clearly proven GENERAL mechanism of the process of gravitational field action, definitively confirming the previously characterized process [2]: Π^{O} (at N) [symbol] (ν_{μs}\overline{ν}_{μs}+γ) [symbol] γ [symbol] (ν_{μ}\overline{ν}_{μ} [symbol] ν_{μs}\overline{ν}_{μs}) [symbol] γ [symbol] (ν_{μs}\overline{ν}_{μs}+γ) [symbol] Π^{O} (at N) {Neutral pion (in nucleus near nucleons-N) makes transformation (possibly through silent neutral pion) according to equ. 3′″ with virtual “photon”, which propagates (being recreated anew each time) from transformation to transformation of active muon neutrino and antineutrino into silent ones. At the end there is the attraction (at last transformation into neutral pion in another target nucleus) of 2nd nucleus. These waves are also spheric, very often, neutral (without any interference with much stronger electic forces) and mutual.}

This process justly could explain the small measured mass of electronic neutrinos and anti-neutrinos (that must be obviously equal to those of electron and positron according to net confirmed transformations) by their very weak interactions with these particles, responsible for the gravitational force. So since today, the gravitational and intertial mass for different elementary particles could not coincide and the relation of their Earth weight to their mass is not constant (gravitational constant g-normally), that makes Newton mechanics quite unusual for such particles. Evidently, the extremely high circular velocities of clouds (with dark matter) around the galaxies takes place only due to strong interactions of such dark matter (muon neutrinos and antineutrions?) with gravitational fields [67;34, p. 207] {The fantastical (even) proportionality to galaxy radius (justly after nucleus of galaxies) indicates the density of nucleus (too dense Black Holes!—§3) AS equal to that of gaseous! dark matter with some relatively seldom stars that is too strange}.

Experimental proofs are for students: beams of ν_{μ} and \overline{ν}_{μ} “enforce” Cavendish experiment. So the nature of mechanism of gravitational field definitively confirms VERY new unusual nature of the electric field [2], that opens the very interesting practical consequences (§4-6).

Justly the above gives the explanation for well known (but unexplained) red-shift of the source at high gravitational mass. The grand concentration of neutrinos (and antineutrinos) must increase the speed value of light increasing efficacity of virtual “photons” (closer distances between neighbouring neutrinos or antineutrinos) according to §2 (1) [with confirming §2 (2)]. So the value of wavelength increases being proportional to the speed value of light. Consequently, such artificial increase of concentration of all neutrinos and antineutrinos leads to the revolutionary increase of the value of light speed in this matter and analogous increase of the speed value of the propagation of electric, “magnetic” and gravitational fields (as well their forces) that (with basic development of §3) conducts to the titanic practical consequences (§4-6).

§3. Titanic Unusual Development (in Centuries Scale) of the Most Global Essential Characteristics of Matter, Possible Only With Data of Cosmic “Laboratory” Due to Einstein-Bohr End ([2], §1). Conducting (With §2) to Vital Practical Consequences.

1). Radical Bases of Consecutive Fantastical Consequences: Light Cannot Leave Our Classical Universe: Global End of 2nd Thermodynamic Century Law!!

The following profound deepest characteristics of matter must change radically all profound Technics.

a). Registrable Strong Light Intensities of Wide Spectra (Since Big Bang), Resting in Universe After Re-Excitations, are Clearly Unexplainable.

According to numerous data, the presence of diffuse cosmic background radiation (present in several spectral regions: from radio waves untill γ-rays, including micro, infrared, visible and ultraviolet waves [68-72]) is so strong that this energy “could be used to heat up all matter (where) the temperature would be greater than thousands of milliards ° K” [73,74], that “remains one of the unresolved puzzles of cosmology” [74]. There is, for instance “strong upper limits to any angular cross-correlation between the CMB (cosmic microwave background) temperature and the extragalactic X-ray background intensity” [70]. Evidently, the radiation of the discrete today sources is added to the background cosmic radiations: a significant fraction of the cosmic X-ray background (XRB) is the discrete sources largely due to the accretion onto massive black holes [75], and the obscured AGN (active galaxy nucleus), that produce a large fraction of the hard X-ray background, logically creates the majority of the background radiation of sub-mm diapason [76], wherein the UV flux, from “early-formed” massive black holes, can be the additional sources of the UV background intensity [77]. Such additions (less than ¼), by discrete sources to the diffuse γ-rays fluxes in Universe, take place too [71].

But the most spectacular radiation is the CMB: exceptionally (not as other regions of spectrum), it is attested as the spectrum of Black Body with the temperature equal to 2.726° K! (“the most perfect black body ever seen” [78]) with totally isotropic radiation [79]. It is accepted that “a sea of black body radiation” relaxed to the thermal equilibrium” was created when “the expanding (Primordial) Universe was dense and hot enough” [80]. But “a homogenous expansion of the Universe causes the radiation to cool as in the adiabatic process”, “when, the interaction with matter was negligible” [80, pp. 131-134].

However, in reality, it is not even very serious. It is not the classical adiabatic process with the piston, where the counter-action force is infinitively weaker than that of action, and consequently, the energy of the work is not transformed into the kinetic energy of the piston. Here, oppositely: there is, justly, the very rapid Primordial Universe expantion with well diminished (“annuled”) work, where the potential energy of the compressed matter is transformed rather into kinetic energy of such matter not only without cooling, but oppositely. Moreover, although they have the Planck spectrum, “CMB photons are not in thermal equilibrium. The mean free path for scattering of photons in the Universe must be huge or else we would not see galaxies and quasars out to distances of thousands Mpc” [70]. Because of such enormous free paths, the great majority of such light had to leave Our Universe instead of staying in such cool diffuse state (it means after unbelievable too numerous re-emissions/including reflections/) with very powerful intensities de facto.

Moreover, due to thermal effects of the obtained (in situ) plasma, its spectrum is different from that of Black Body in vacuum [81], and the experimental agreement with models of the angular CMB spectrum temperature structure “is not exact”, “causing some ferment in the cosmological community” [82]. Consequently, one can already reason that the origin of the presence of the enormous diffuse light intensities in the Universe does not have any connection with Planck spectrum Acceptance of Planck spectrum absence in CMB makes very interesting consequences [Refs. 82].

Moreover, classically, the Planck radiation law was certainly based on the experimental data obtained from measurements with the cavity radiation. But the relation, necessary for consecutive generalization (quantum energy of radiation is proportional to its frequency: other formula of Planck-Einstein) is the evident principal falseness [2], that already, itself only, eliminates the application of the empirical law (established only for the cavity) for more general utilization. If is shown clearly, that the presence of the strong intensities of the electromagnetic diffuse waves (light) of the large spectrum in the Universe asks another explanation.

b). Real Light Deflection Near the Gigantic Masses.

The light deflection near the gigantic Black Holes as those of Schwartzchild is well established: more than dozen multiple images (due to lensing of quasars) are already known [83-85]. The effect is net: the black hole shines due to the star (galaxy) light, falling on it because of the influx with help of the “gravitational lensing” [84]. One detects the same influx with the CMB radiation localized by Sun [86].

c). It is Neutrino (and Antineutrino) Concentrations that Decide Light Direction: Complete Light Reflection from Universe Borders.

Today, one knows already, that the gravitational lensing, as consequence of Theory of Relativity, does not exist because this theory is false [2]. But what is the origin of such light deflection near great masses? It is confirmed already, that the light propagation (and velocity value) are determined by the velocity transformation of neutrino (and antineutrino) with the moving front of the electromagnetic wave. Naturally, a stronger neutrino concentration guarantees a larger value of light velocity (for instance in vacuum, the neutrino concentration as well the value of light velocity must be stronger than in water).

But near gigantic masses, the neutrino concentrations (with electron mass [2]) are higher, that must produce the same effect of the refraction/as with increase of refraction index (n), where there is more space for neutrinos/(to see, for example, also the classical spheres of Huygens), that one, justly, observes, de facto, near Black Hole and the Sun [83-86]. Evidently, in absence of Big Bang neutrinos (also imitating the absence of space and too high n) at the exterior of the expanding Universe [87,88], the complete light reflection from the Universe borders (as from mirror) takes place, that must happen a number of times.

This is clear and simple basis of the presence of enormous quantities of diffuse light (of all spectrum naturally) radiated since Big Bang in Universe. Normally, the CMB Intensities, (only) from the opposite (diametrically) directions of the sky points, are identical (“this is an obvious fact” I.N.) [89, p. 258] (numerous complete reflections “up and down”), where, evidently, in each “complete” direction (“whole diameter”) there is own level of absorptions (of spectrum waves) by the galaxies or other cosmic objects [90]. Consequently, the CMB waves have the blue shift in the direction to the observer [82]. Naturally, this Universe, that is not close, can only effectively be presented as the closed one if it satisfies the particular observations [91]. But this approximate replacement does not have to be well solid. For instance, after profound works [92], one cannot see “ghost” images of the radio sources, expectable at positive “space curvature” (“closed” Universe) and positive cosmological constant.

2). Different Consecutive Big-Bangs and Galaxies Origin: Exemplary Convergences.

a). Positive Cosmological Constant: Universe Mass is Essentially Greater Than the Critical.

The last data (on the Supernovae), accepted in unisson enthusiastically by community, propose oppositely, that “expansion of the Universe has been accelerating rather than decelerating in the recent past” [93-95] and moreover “the matter density of the universe . . . is a factor 3-4 less than required for closure” [93] [see also §1(3): simple annihilation of such acceleration]. Fortunately, such new triumphing information is too far from the verity, however clear. With the relatively large mass value, proven for light neutrino and antineutrino (equal to electron one) [2], one can easily calculate that such neutrinos (and antineutrinos) represent even (even!) more than 99.9% of the Universe mass, if to accept, the following calculations. “If the neutrino has the mass of . . . 5 eV then roughly 30% of the mass in Universe is in the form of light neutrinos” [70]. Such neutrino and antineutrino mass values are, again, well confirmed by the spontaneous orchestra of the new data, concerning the connection between the Supernova explosion and GRB (gamma-ray burst—§3.2e.). Universe, dominated by neutrinos, was predicted yet by D. Schramm and G. Steigman in their prize work [88].

b). Imminent Universe Collapse Due to Enormous Energy Concentration.

Consequently, since one moment, Our Universe will begin to contract (after end of expanding) due to Universal Gravitation Law Forces. So the restricted light (electromagnetic waves) volume will diminish and the general Universe entropy will even decrease. Globally, the 2nd classical Thermodynamic Law is invalid not only because of the limitations, connected with the unpermeable (to light) Universe border, but cheifly, due to cooperation between two laws: reflection of light from Universe border AND Universal Gravitation. Surely there is no entropy death of Universe.

But due to enormous decrease of the Universe volume, all electromagnetic energy radiated by all stars during all Universe existence (since last Big Bang) will be concentrated in very small volume. And only due to such CONCENTRATED ENERGY, the colossal explosion (New Big Bang) will take place. Moreover, anyway, the powerful explosion, provoked DIRECTLY only by gravitational collisions is not really imaginable, for instance, with the inertest dominating already dark Universe materials of neutro (massive Black Holes, “neutron” stars); besides, with a number of de-synchronizing factors as natural nonperfect ELASTICITY of the SUCCEEDING collisions. In reality, the situation is more delicate. There is the presence of several types of Big Bangs and the real presence of Other Universes with mysterious only (!) ultrahigh energy cosmic rays (that Our Universe does not have) [2], confirms such differences. Evidently, the dispersion of values of particle velocities of such explosion must routinely produce the registration (at too distant Earth) lasting long time (exclusively too high energy cosmic rays!).

c). “Our” Big Bang: Explosion of Universe Was Until Atoms of Hydrogen, Helium (and Some Traces of Atoms of Li, Be and B).

Fortunately, all traces do clearly exist (and even in strong relief). There is the existence of the universal abundance of the primordial helium (25%!) (and also the traces of deterium, litium, beryllium and boron without other heavier elements) [96-102]. To explain this, they imagined the “Big Bang nucleosynthesis” (BBN) with the creation of light nuclei, deuterium, He-3 and Li-7 during 1st minutes of Universe [98,101], and again, one imagines this nucleosynthesis as having the abortion, without reactions, producing the heavier elements from carbon, that takes place during the stelar nucleosynthesis, responsible for the formation of the totality of other nuclei, from carbon until uranium [101]. To explain the presence of the traces of light elements between He and C, they introduce, already, the process of spallation of the heavier nuclear species (C—N—O) by collision with the easy species (H and He) [102]. (For instance, Li must exist since beginning because there is the abundance of Li in the galactic gas during all time of the Universe existence [100]).

But justly THIS process of spollation of the heavier elements must take place during the Universe explosion to obtain the easier elements de facto: H and He principally. It was, justly, the process of “Our” Big Bang! The elements as Li—Be—B had to be produced also after this explosion of Big Bang with spoliation but with weaker quantities and, again, these elements are more fragile [96,102].

One sees that there were no other MORE POWERFUL successive explosions in the more contracted Universe state during “Our” Big Bang because of the presence, of such masses of light elements since “beginning” of Universe. Evidently, this temperature of explosion was weaker than that necessary to “recover” the masses of neutros (black holes, neutro [“neutron”] stars) by reactions, that are opposite to those of the neutro creation [2] (at enormous excess already of concentrations of neutrinos, antineutrinos and neutros).

Consequently, after this great explosion of the heavier elements, their transformation into hydrogen and helium principally, the great masses of Black Holes near the centre of explosion and farer (evidently, yet moving to the mass centre of Universe) had to meet the powerful currents of the hydrogen and helium masses after explosion. And justly, this process proves the Galaxies origin, never imagined by anybody since Ptolomee and Copernik, Galilee, Newton and Kepler.

d). Galaxies Origin and Star Movements: AGN with Black Holes as Centipetal Force.

Naturally, the creation of stars due to activation of synthesis reactions (from produced hydrogen) was done only at the beginning of Explosion. This explains the same accepted grand age of elliptic Galaxies, much higher Sun age [2], absence of the star creation even at TOO favorite conditions near the titanic Black Holes [103], Universal presence of hydrogen (H II) around justly “young” stars [104] (certainly they look like “young”, only because of hydrogen feedings! as Sun [2]), very astonished polarization within the disk and origin of rotational movement of stars. And justly, the gigantic luminous masses (as massive Black Holes) are present (insistently) at mass center of all galaxies (AGN-active galaxy nucleus) [103,105-108].

If the hydrogen (and helium) flows (from Explosion direction) (“above” and “under” “waiting” Black Hole) are sufficiently different and there is strong presence of gases, dust and Dark Matter (making untraversable dense shield “against” stars of opposite current as in the case of Spiral Galaxies (1041), the rotation of star bulk takes place finally in one direction [104] after “struggle” of opposite currents. So almost all Galaxies have signes of damages [109]. This is the clear cause of appearance of spiral arms: In zones of meetings of two flows there is the increased collection of gases, dust and dark matter. Wherein the “struggle” was shorter at a smaller distance from galaxy center, because logically, at mutual knockings of two flows (resulting in decrease of speeds of matters of flows and falling on AGN) and with (also at the same time) linear movement of AGN (under force of direct rectangular flow from the same Explosion), decreasing the distance with matters of flows, moving already around AGN, there is a more powerful exhausting and a quicker end of a weaker flow!! Such spiral arms rotate generally as whole due to (PROVEN—§2b) well strong gravitational forces of dark matter in spiral galaxies. But in the case of elliptic Galaxies level of dust gases and dark matter (logically with them and there is no such rotation curves with radius in this case) is much less [104]. So there is no stopping “shields” between two flows and they must continue to rotate in own directiion. And justly!!! here “we often find separate components, even rotating in the opposite direction to the bulk of the galaxy”. [104,110, vol.1, pp. 721-728]. The rotation of globular clusters (large number of stars in each) in different directions of even spiral galaxies [104] (which were out of struggle against contreflows), confirms comfortably this process as well as presence of “coherent” elliptic orbits in evidence [104,110]. Such unisotropy of directions of initial flows (from Explosion) is reflected by the “asymmetric drift”. Wherein “the directions of motion of the stars of high velocity . . . avoided the greater part of the sky” [Refs. 111, p. 361;104] (also for instance [112-114]).

Analogically to formation of Solar system (wherein all planets conserved angular momentum of exploded Supernova, rotating in the same its previous direction) [2], there were the flows of hydrogen (with stars), that were “higher” “lower”) than the principal Galactic plane of rotation around AGN. So the similar force (vertical projection of gravitational force between AGN and such stars) directed these stars again to the central plane of disk. Consequently, the clouds with hydrogen with strong velocities with prominent orbit (at >2 kpc from galactic plane) [115], reflect their original removal from centre of mass of AGN (as Pluton orbit [2]!).

Quasars {the brightest in Universe with strong red shift: z=2-3 [105-107]} are propulsed stronger (red shift higher) when they are brighter (taking larger part of exploded luminous matter with its AGN of previous Galaxy) (including closer Galaxies Seyfert with more massive AGN) [105,107].

e). More Powerful Big Bang Takes Place When There is No (Almost) Heavy Elements: Only Neutro Masses.

The stars from hydrogen and helium transform these constituents into (finally) the heavier elements and into black holes or “neutron” stars, composed of neutro [116]. Evidently, if, finally, heavy elements (after these star explosions) are all (almost all) transformed into neutro, the “1st” weaker explosion will not take place and Universe will continue to contract with critical temperature increase to have the capacity to inverse the reaction of Supernova explosion [2].

Justly, the mechanism of the beginning of Supernova explosion (that gives the experimental basis to establish the most principal equations of Nuclear Physics), published yet in XXth century [2], is well confirmed by one . . . explosion (very recent) of experimental publications. Naturally, the most powerful Supernova explosion must begin by creation of γ-rays with neutrinos and antineutrinos (“annihilation” of electrons and positrons) [85]. And justly, one confirms well today that there is the association (connection) between explosion of Supernova and GRB (gamma-ray burst) [117-122] that (both) are more spread at the regions with stronger shift [z (mean)=1.5-2] [121]. Justly the GRB have “afterglows” [117] and the observed Supernovae must be such optical “afterglows”. By the way, for instance, the correspondence between several neutrinos and antineutrinos of powerful Supernova 1987A, visible by naked eye and the visible light must be the real coincidence because the directions of these neutrinos do not correspond to this source and moreover, this is even naive to consider the velocities and of light as almost equal (probability is almost zero!).

Consequently, such Big Bangs must be much more powerful. Moreover, all stars are extinguished in the moment of Big Bang: there are no stars in Our Galaxy that have 20 milliard years [107]. And justly, the most powerful cosmic rays from Other Universes [2] can be associated with such Big Bangs (duration in time corresponds to dispersion of velocities!). Justly, again in confirmation: such too powerful “rays” exist today in Our Universe [2] and there is no correlation between the directions of (their) arriving and their optical sources that can be identified clearly [123]. The naive cause (distance close to us! but without ANY serious identification) of the absence of cutoff of protons of cosmic rays of such titanic power does not explain the origin of these rayons at less than 50 mpc from us [123]. This absence of cutoff is due to their speed, (much) higher than that of light, where there is no interaction between the proton and electric (and magnetic [“magnetic”]) field of substances on the pathway for such particles from other Universes!, with these dynamic fields (with frequent re-creation of waves of very frequent transformations of neutrinos into electrons) having “only” the velocity of light [2]. The fact of noninteraction, justly proves the DYNAMIC nonpermanent “frequently temporary” character of the electric fields: the protons [124,125] of the cosmic rays pass the Sun (well charged) and the Moon [125-127], but do not pass even several meters in the water [128], confirming TOO evident evidence of the value of their velocity higher than that of light (and their existence!) and again evidently, the definitive end of Einstein-Bohr Physics [2].

The unexplainable fact, that certain radio quasars and also simple radiogalaxies are the sites of the “superlight” velocities, wherein the spectrum components are separated with velocities higher than those of light (according to red shift value) [107], confirms again this chain of the proofs of the end of Einstein-Bohr Physics.

f). Proofs of Presence of Charged Particles With Speeds Much Higher Than Those of Light and Absence of Their Interaction With Electric and Magnetic Fields.

After New developed and confirmed Physics [2], the perspective of the new Era in Technical progress of Humanity is taking already the dimension of the science fiction, far even from imagination of Jules Verne.

After the discovery of the real nature of the electric field (developed much farer than that of Faraday and Maxwell!!), one knows that it is the presence of neutrinos and antineutrinos that is necessary for propagation of the electric field and of the light. It is their temporary transformation into electrons and positrons that quarantees the propagation with the distance of the vector of the intensity of electric field (action of proximity) (but with very strong frequency). Also the speed of propagation of this transformation determines the speed of propagation (of action) of the electric (and magnetic) field of the light [2], that must be dependent on the concentration of neutrinos and antineutrinos.

Only the small quantity of the cosmic “rays” of isotrope and stable intensities (charged protons in majority) is stopped by the enormous charged matter of Sun and by rigid matter of Moon [124-134] with weak difference of order of 3σ (standard deviation) between the flow of the background and flow of the shade of Moon (and Sun) (for cosmic rays with different energies from TeV to PeV). The fact that the shade of Sun is less important than that of Moon (having much weaker magnetic field) [135] confirms that the magnetic field is not the cause of effect of the shade (even weak). But why did these charged protons pass easily through the Sun and Moon but not through ten meters of water [128]. It is impossible!

And one can even well conclude, that (and I do not see any other explanation) it is because of the value of the speed of cosmic rays that is superior than that of light: evidently these particles (with such speeds) do not interact with electric field (and magnetic) in the matter of Sun and Moon (having the value of the propagation speed weaker than that of particles) and they pass (almost entirely) the gigantic masses! The seldom stoppings of particles (very weak shade) is due to direct knocking of the matter (itself) of the nuclei of Sun and Moon. The effective diameter of the charged nuclei is the order of fm [136]. But again, this is the effective diameter of the action of the electric fields of nuclei in such or such experiment, that must be much smaller (as well the matter, which is knocked directly)!

Let us calculate, after classical formula, the kinetic energy of proton having the value of light speed. It is equal to 470 MeV. In the parallel proof, justly, the spectrum of energy of cosmic “rays” stops (justly near maximum!, it means: cut, naturally) at this diapason (having the cutoff at weaker energies). The cosmic rays of energy less than 100 MeV do not arrive to earth [137]. The explanation that it is because of Earth magnetic field [137] is not professional for World Science. For example (even too simple), with direction of lines of magnetic field at poles of Earth, there is no any deviation, moreover at values of speeds close to those of light. It means, justly all cosmic rays have the values of speed that are superior than those of light and they pass all obstacles in Cosmos: Galaxies, Black Holes, Universes. The fact, that the directions of these cosmic rays are isotrope (including even that of Sun) [137], confirms their macroscopic origin: from (and by!) all universes in the infinitive space, during all infinitive times justly, without having the serious obstacles because of the values of speeds, superior than those of light. And these rays, that have the weaker values of speed, had to be stopped earlier or later, closer or farer in enormous Cosmos. “At “very weak” energies, the cosmic rays of particles are the object of ionization, losses” [138].

g). Mystery of “Spontaneous” Radioactivity: it is Invisible Rare Direct Knocking of Nucleus by Cosmic “Rays”

The initiating cause of process of radioactivity, discovered by Becquerel (and very much exploited later), was never really explained. So “classically”, it was claimed as “spontaneous” (In similarity with Reigning Probability without known really forces [2], that was definitively annihilated in §1) [48]. But the precedent very basic development with also very seldom process of direct knocking of nucleus (without participation of electromagnetic forces in atom having much more larger effective radius, than the nucleus) permits to conclude that each radioactive decay is directly stimulated by each effective physical knocking with very high kinetic energy: particle-nucleus (Justly that one can have at good accelerators of particles!). Evidently, the stability of the nucleus (or rather: minimal critical effective energy of “rays”, from which there is already the switching of particular nuclear radioactive reaction) determines the period of radioactivity, that is different for different nuclei. But the cosmic radiation is similar everywhere in space and in time. So this discovery of the nature of “spontaneous” radioactivity (that was the beginning of the new era of the science) is already extraordinary as such being simple consequence of previous very basic developments.

CONVERGENT BASIC NETWORK MAKES CAREFUL SOPHISTICATED APPLICATIONS. Such signifiant complex of superglobal characteristics of Physical Matter makes the general definitive order for New Created Physics, instead of that of Einstein-Bohr with (based on it) Bases of Modern Physics, that were exercising the clear impass for CORRESPONDING development of Principally New Science and Technics already during century! This new fantastical development [of 2]again confirms and definitely convinces Scientist and Engineer. Wherein only these extraordinary basic developments (§1-3) permitted me to invent (as their CONTINUATION) the super-sophisticated practical RADICAL innovations (very impressive and never even imaginated before (§4-6). It is done carefully!, without doubts in such too unusual field, eliminating Whole Chapters of The Classics!!, confirming itself with help of too numerous experimental data with wrong use) by all converging network of global basic characterstics of Physical Matter.

Note for proof. In the proved end of Michelson Nobel experiment [2] (that itself! PROVES the end of Theory Relativity), the slips (only) in mathematical calculations took place. So because of extreme importance for all World Basis of Science and Sophisticated Technics, I must give here (Supplement 1) the clear correct proofs.

§4. Ultrasophisticated Innovations as Practical Consequences of Whole Invention. Titanic Temperatures, Imitating Discovered Process of Big Bang, Changes of Periods of Radioactivity and Superaccelerators for Particles and Production of Effective Beams of Neutrinos and Antineutrinos.

Evidently, such developed process of Big-Bangs (well proven) permit to create the very elevated and permanent temperatures. After routinely having the classical intensive radiation in the volume, limited by the exterior absence of neutrinos and antineutrions (with help the classical radiation of the intensive γ-rays and perpendicular electric fields, that move away the electrons and positrons, created from neutrinos and antineutrinos by such radiation), one can diminish this volume (in similar consecutive elimination of neutrinos and antineutrinos), imitating the contraction of Universe (§2,3), that permits to have the well elevated concentration of the electromagnetic energy in very small volume with too elevated permanent temperature. Such creation of elevated and permanent temperatures, one can make with help of the routine technics, clearly descibed in patents as: WO 00/69769, 00/25152; EP 234150, 404681, 008967; FR 2770648, 2729765, 2720506, 2619622.

Changes of periods of radioactivity. After clear establishment of the concerte nature of the radioactivity (due to knocking by cosmic particles but not the spontaneous) (§3), one can easily change such periods in protecting the sample by dense matters. The very thick layers of heavy elements (very dense, with grand nucleus) like uranium or of matter of new particle neutro, the most dense matter of “neutron” stars [2], can diminish the level of the cosmic rays and consequently to change the period of radioactivity! This is very important to obtain (production) the very unstable elements (costing thousands times more than gold) like mendelevium (atomic number is equal to 101) or rare isotopes that are produced during chains of radioactive reactions of decompositions. There are a number of the best special inventions to obtain such strong layers of protecting substances (armour) like layers of cement, steel, lead, copper, cadmium and even adapting layer of resin epoxyde (that, one can simply to remake): WO 00/36611, 00/52707, 00/52708, 96/36972; EP 757361, FR 2776118, 2790588, 2790589, 2776118. The best written production of isotopes is well described in patents as WO 01/15177, 00127477 and EP 0962942.

Sophisticated accelerators for particles having values of tens (see hundreds) of velocities of light. Today, for some augmentation of energy of particles (necesary to go into deeper knowledges in Nuclear Physics or for preparation of the radioactive isotopes), one constructs the accelerators having size of tens of kilometers!!!, which cost milliards and milliards. But with this (already undenyable AT ALL!) deepness of the science (§1-3), one can effectively increase the values of particle speeds above any dream. II was not the “increased” mass of the particles, that prevented the consecutive acceleration (according to falseness of Theory of Relativity), but principal impossibility to accelerate the particles having the speed value close to that of the light with electric field having the speed value of propagation also approximately equal to that light (§1-3). This resulting evident instability and also consecutive periodic vibrations of charges in the field during such movement cannot not to be the sole cause of the synchrotron radiation with the strong particle speeds and the Tcherenkov radiation, because the sole possibility to create the electromagnetic wave is the periodic movement of the charge in electric field, in making the obligatory! work against New Force discovered by me [2, and §1]. So, due to the most Profound undenyable science, ever existed (carefully §2,3) in increasing ν_{E} and/or \overline{ν}_{E} concentrations (with beams) in accelerating electric and perpendicular leading “magnetic” fields, one increases, proportionally, the speeds and forces of these fields increasing stongly particle energy. So these oversophisticated accelerators permit to make superhuge energies (never seen in natural process in any Universe?!) that certainly explains interaction of colliding particles (without known fields) by huge forces of particle cohesion. Routine description of ancient classical particle accelerators of numerous types is too abundant in the Classical Books of Science and Technics and in Industrial Property [32, vol.13, pp. 126-155; 139-142]. The productions of the radiation of synchrotron (with its numerous applications [32, above], as the integrated circuits too!) are routine technics, written in numerous patents as WO 91/01076, EP 813255, 582193, 531066, 265797, 361956, 481865, FR 2722327, 2607345, 2594621.

Production of the effective beams of neutrinos and antineutrinos. There is evidently the important number of very current technics for production of beams of neutrinos and antineutrinos (electronic) (to see best Refs. in [143]). But the best means to create the beams of neutral particles is to make the interaction between the well configurated charged particles (electron and positrons) with help of the magnetic fields (very well descibed [144,145]), as circular and linear collisionners wherein as result, there is the creation of neutrinos and antineutrinos and of the γ-radiation, discovered 1st time by me [2]. (“Positron monochromatic beams of high intensity and weak energy” (and strong one) are well makable too [144]).

But (using my superknowledges [2 and here]: complete creation of neutrinos and antineutrinos from electron and positron without mass dissapearance), I specially invent here the neutrino and antineutrino beams of the best configurations. Evidently, the best direction to have the well directed beams of neutrinos and antineutrinos (electronic) is the meeting of the beams of electrons and positrons, moving in the same direction, wherein the resulting beams of the neutral neutrinos and antineutrinos are directed in the same directions and well focalized. The dipole (perpendicular to movement), created, at the beginning, during such approchment at parallel movement must produce the vibrations of charges and the electromagnetic waves (one charge in field of another: obligatory condition for wave creation) in directions of movements! This was done de facto in “Device and method to generate the laser radiations of gamma rays” [EP 0715381], wherein the sufficiently routine technics (almost the same as in [144-145]) was well written with details [EP 0715381, 146-147], wherein as result there is “the forward gaser, that is the laser of monochromatic γ-rays, having the energy superior than several MeV and the back monochromatic γ-gaser” with E<200. KeV″ [EP 715381]. According to my original and revolutionary proofs ([2] and §1,2), during such interactions of electrons and positrons, there is the creation of the neutrinos and antineutrinos (electronics, evidently) with the same masses (instead of the transformation of the masses in energy E=mc², accepted and established as New Classics by whole world without ANY challenging). Without doubt according to Mechanics, the strong momentum of movement of electrons and positrons in the directions of the beams cannot change the directions and there is the creation (at the same time) of the beams of neutrinos and antineutrinos according to my discoveries ([2] and §2). It means the obtaining of the perfect SATURATED beams of neutral neutrinos and antineutrinos is clearly makable and well described.

§5. Production of Electromagnetic Waves, That are Shorter Than Gamma (<0.002 Å), Never Observed, and of Electric Currents, Never Produced. Direct Transformation of Electric Energy Into Electromagnetic Waves (With Efficiency ˜100% Instead of Lamps).

But from these new accelerators with values of partcile speeds much stronger than those of light, one can produce electromagnetic beams with astronomic frequences, never observed and never observable, moreover with “positive” and “negative” charge type of light (p. 16).

It is well known that the synchrotrons (rings of the stocking of charged particles) produce the coherent well polarized stable electromagnetic radiation (at values of particle speeds close to those of light), as pulses with duration of 30 psec and interval between pulses of 1 μsec, wherein this radiation is situated from infrared untill X-rays (hard) [32, v.18, pp. 102-110] and until γ-rays in the case of betatrons (also synchrotrons in reality) [as EP 0481865, FR-2594621]. This radiation with these frequences (including the astonishing ones until 1.8×10²¹ Hz!! of hard γ-rays) takes place (but with weaker intensity) even without undulators or wigglers, that produce periodic transversal oscillations of the beam (with magnetic field) (but with frequence much!! weaker) [32, v.18].

Light of Tcherenkov (Cerenkov). These vibrations at very high frequences take place justly due to relativist instabilities (The “Nobel” LIGHT of TCHERENKOV is of the same nature!), when the value of particle speed approaches that of electric field propagation. The electric field, is the pulsations of beginnings of the temporary transformations ([2] and §2): neutrino [symbol] electron and antineutrino [symbol] positron (for negative and positive charges respectively) without energy dissipation ([2] and §2). In reality, the value of this speed of propagation of the electric field is some higher than that of light [although also the local transformations but of the transversal wave of neutrinos (antineutrinos) into electrons (positrons)]. This is not the same process althought they have (both) the same transformations basically. Tcherenkov effect confirms this: justly when the speed value of the charged particles is situated at the limit of the value of propagation of the electric field in the medium, the intstability of the interactions takes place (and this particle speed value is some more than that of the light in this medium). Justly, these instabilities are transformed into the vibrations of these particles (in all directions relatively its trajectory), which are transformed (in their turn) into the vibrations of electrons (surrounding (in fields of nuclei and other electrons), that radiate the waves of the visible frequences.

Evidently, in these new accelerators (synchrotrnos, rings of storage of charged particles), wherein the analogous “relativist” destabilization takes place with much higher speed values, there is the production of the waves with colossal frequency values, which are much greater than the value of 1.8×10²¹ Hz, never seen. The Lorentz force of the charged interactions of particles is also proportional to their speed value. But one can utilize these beams of the new superfrequent coherent polarized waves (obtained in the 1st time) for production of the electric current with the same impressing frequence. Evidently the intensive light between two charged metallic discs (like of condensator) must change the conductance (resistance) of this condensator and consequently it must change the value of current of the electric chain with this condensator according to simple Ohm law. The deviation (to Sun) of the light at the Sun eclipse (famous Einstein experiment) justly confirms this (but not famous Theory of Relativity: to see definitive proof, of its end: WO 00/52989 and Supplement 1 here) and again at two types of the propagations: light (with interchanging variable electric and magnetic fields-[2]) and electric fields (with frequent periodic fields-[2], §2), there are always the transformations of the same neutrinos (antineutrinos) and electrons (positrons) with evident inter-influence. But in order to make the changing of current with propagation of the coherent polarized wave, one must make the slit (or a number of periodic slits) in the insulator between two condensator discs with size (to pass) of only the half of wavelength space. The direction of polarization of these waves must be perpendicular to the condensator and insulator parallel discs. To make such slit: one takes the transparent plate (“carcass”), “half” of which is covered by insulator and descends the plate (by transparent end) into vessel with again liquid (melted) insulator (that will be fixed in solid state on plate) until necessary small size (largeness of half of wavelength) of resting (long) slit space. (rest by maximal modulation!) After consecutive electric filtration, the ultrafrequent current is produced.

But honestly, one should certainly avoid the utilization of even such extrashort pulses in too numerous relaxation technics (hundreds of very expensive works with compex equipment each year!) with observation of (relatively rapid) fluorescence decays with photomultipliers. It is too obvious proven artefacts that stop World Technics and Science for tens of years (to see important [specially made] detailed Technical proofs in Supplement 2).

Evidently, the electric currrents can produce the powerful electromagnetic waves of all frequences, including those of the visible light (with help of too simple condensator and induction) like the radio waves. In the case of the visible light this is the lighting of the direct transformation of the energy of electricity into that of light with efficiency ˜100% instead of several percents with lamps at present. One can utilize these electric currents for technological and scientific purposes like the mesurement of the most rapid processes like justly the switching of the transformations neutrino [symbol] electron during the propagation of electric field.

Evidently, these electromagnetic waves with all their frequences can be utilized as carrier waves for any radio or tele communication. Certainly, one can choose the perfect conditions without attenuation (practically) of the wave intensity (for instance even through Earth).

§6. Crossing of Neutrino Beams With Particle “Rays” With Superastronomical Speed Values: Powerful Destruction (Analogous Neutrino Beams Increase Gravitation).

One saw (§3) the stong proofs of the existence of the particles with the velocities greater that those of light, that almost does not interact with matter and can traverse any obstacle. Evidently, light speed value in the obstacle matter depends on concentration of neutrinos and antineutrinos in this matter. And in increasing the concentration of neutrinos (and/or antineutrinos) (with help of neutrino [and/or antineutrino] beams) in any distant defended point, one provokes the interaction of the charged particles (having the speed values higher than those of light) with “touched” (by electronic neutrino [and/or antineutrino] beams) substances, because the the light speed value must increase proportionally to the concentrations of neutrinos and antineutrinos in these substances. Consequently, one can destroy this substance, even situated profoundly in Earth or Ocean or even at another side of Earth (as in South America!). One conducts the beams of charged particles (as protons or electrons) having the speed value higher than that of light (superpenetrating!) and one makes the crossing of these rays with neutrino (and/or) antineutrino beams: chirurgical important destructions! One can utilize even the natural cosmic “rays”, making their interaction with desired substance with help of powerful beams of neutrinos (and/or antineutrinos) because the quantity of the real noninteracting cosmic “rays” [even too strongly charged: heavy nuclei completely ionized and having (all!) the speed value greater than that of light—§3] is much much stronger (in milliards of times after their almost intact crossing of Sun), than that detected (§3), because of the absence of interactions with electric and magnetic (“magnetic”) fields of the medium. Evidently with such above crossing (even with help of only cosmic “rays”), one can destruct the rapidly moving objects too. One can make also the “simples” portative guns or pistols, firing by concentrated beams of neutrinos and antineutrinos, making powerful interaction of too powerful cosmic “rays” with target substances. Evidently pacific utilization as destruction of mountains or construction of tunnels is natural. The neutrino-antineutrino beams, developed by me here (§4), must have the best focusing properties, absolutely necessary for distant applications!

Purely analogically, one can utilize the beams of other muonic neutrino and/or antineutrinos {as well other beams [as pion or muon beams] conducting to the same increased presence of muonic neutrinos and antineutrinos (§2b) with excellent Refs. for beams} that can stongly increase the gravitational force. This local increase of gravitational forces can be utilized for instance for registration (in incredible chaos of often wrong reactions of nuclear physics [2]) and separation (with purification) of short living, light or weakly interacting particles, that are too expensive!

See also the developed patents U.S. Pat. No. 3,970,936, U.S. Pat. No. 5,079,532 and EP 081314, that could be used for above beams.

Supplement 1. Extremely Important (for World Technics and Science) Proven End of Michelson Experiment, Making (Itself) End of Theory of Relativity (Corrected Proofs).

The very precise physico-mathematical END of the MOST FUNDAMENTAL Nobel Experiment of Michelson was done in my basic original previous work [2: PCT/IB00/00843, pp. 27-30]. Because of the number of the clearest slips and extreme importance of such proofs, ending (already themselves!) with Theory of Relativity (its Principal Postulate!), basis No 1 of Modern Physics and Technics, I show (in this profound development of PCT/IB00/00843) the correct proofs of the gravest experimental error in Science History.

1. Time Path Difference at ONE Point O [symbol] O′ of Observation.

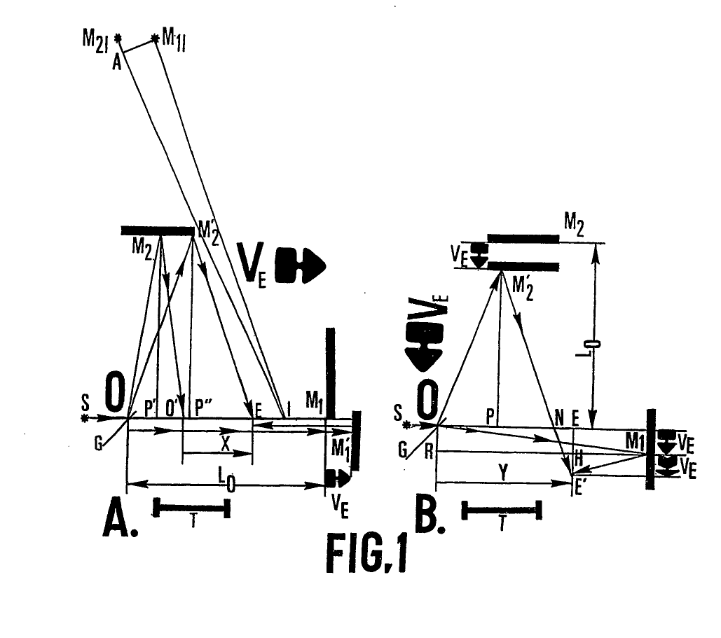

Let us, firstly, calculate, at the POINT O (becoming the point O′ at the end of the light movement due to the Earth movement: O [symbol] O′) of the light beam division in two parts (to see FIG. 1A with footnotes), the time difference of the parallel (∥) and perpendicular (⊥) (to the Earth movement) beam part paths.
(M₂O)²=c²(t_{⊥}/2)²=(P′M₂)²+(P′O)²=I_{O}²+V_{E}(t_{⊥}/2)², where t_{⊥}—is time for path OM₂O′.
   Hence: t_{⊥}=2I_{O}/(c·√1−β²)≈(2I_{O}/c)·(1+β²/2) (1),
   neglecting the terms of higher orders of β—very small value.
OM′₁=ct_{II→}=P′O+P′M₁′=I_{O}+V_{E}t_{II→}, hence t_{II→}≈I_{O}·(1+β+β²)/c,
M′₁O′=ct_{II←}=M′₁P′−P′O′=I_{O}−V_{E}t_{II←}, hence t_{II←}≈I_{O}·(1·β+β²)/c,
   where t_{II→} and t_{II←} are the time for the ∥ pathway to the right and left (FIG. 1A).

So, t_{II}(total)=t_{II→}+t_{II←}=(2I_{O}/c)·(1+β²) and

Δt (at O′ observation point!)=t_{II→}−t_{II⊥}=I_{O}β²/c (time difference),

coinciding with Michelson and Morley result [148,149], although they maked simplified geometric calculations but yet considering (with James Maxwell) “that light waves are propagated in the free ether in any direction and always with the same velocity with respect of the ether” and tried to find the “ether drift” of changing of the relative velocity between light and Earth.

Hence the path difference Δ=I_{O}·β²=3200 Å (at β=10⁻⁴ and I_{O}=32 m Dayton Miller conditions[150]) and Δ=32μ (at β=10⁻³) at point O′.

2. Time Path Difference at ANY Point of Observation (FIG. 1A Configuration).

But one can see from FIG. 1A, that the time difference between ∥ and ⊥ beam paths depends on the observation point of their meeting, that, however, never was really considered during already the century of the World success and very intensive discussions.

Let us calculate the above time difference at some observation point E (at the distance value x from O′ with order of value of OO′, it means I_{O}·β (where OO′=V_{E}t_{⊥}).

2.1. ⊥ Path OM₂′E.
OM₂′=√(M₂′P″)²+(OP″)²=√I_{O}²+(OP′+P′P″)²=√I_{O}²+(OP′+x/2)²
OM₂′=I_{O}·√1+(OP′+x/2)²/I_{O}²≈I_{O}+(OP′)²/2I_{O}+OP′·x/2I_{O}+x²/8I_{O}, where
OE−OO′=x, hence OE/2−OO′/2=OP″−OP′=P′P″=x/2.

Analogically, OM₂=√I_{O}²+(OP′)²≈I_{O}+(OP′)²/2I_{O}.

Hence OM₂′=OM₂+OP′·x/2I_{O}+x²/8I_{O}, so in taking the total ⊥ path (OM₂′E) and dividing by c, one has: t_{⊥}′ (path OM₂′E)=t_{⊥}+OP′·x/I_{O}c+x²/4I_{O}c.

Therefore, using equation (1) and introducing V_{E} in 2nd term:
t′_{⊥}=2I_{O}(1+β²/2)/c+(OP′/V_{E})·(V_{E}/c)·(x/I_{O})+x²/4I_{O}c.

Hence with relation OP′/V_{E}=t_{⊥}/2 and, again, using equation (1), we have:
t′_{⊥}=2I_{O}(1+β²/2)/c+β·X·(1+β²/2)/c+x²/4I_{O}c.

2.2. The ∥ Path OM₁ E.
OM₁′(t′_{II→})=ct′_{II→}=OM₁+M₁M₁′=I_{O}+V_{E}t′_{II→},
   hence analogically: t′_{II→}=I_{O}/(c−V_{E})≈I_{O}(1+β+β²)/c,
   and equally M₁′E(t′_{II←})=ct′_{II←}=M₁′O−OO′−x=I_{O}+V_{E}t′_{II→}−2I_{O}·β−x /using equation (1), we have: OO′≈2I_{O}·β/. With the above equation for t′_{II→}, we get: M₁′E=I_{O}·(1−β+β²)−x and (t′_{II←})=I_{O}(1−β+β²)/c−x/c.

So t′_{II} (total)=t′_{II→}+t′_{II←}=2I_{O}·(1+β²)/c−x/c.

2.3. Equality Point.

t′_{II} (total) decreases with x and the t′_{⊥} increases with x. Let us find the x at Δ(t′_{II}−t′_{⊥})=0 (Δ−difference). One has the second order equation relatively x:
2I_{O}·(1+β²)/c−x/c−2I_{O}·(1+β²/2)/c−βx·(1+β²/2)/c−x²/4I_{O}c=0 (2)

As consequence: x²+4I_{O}x+4I_{O}·βx−4I_{O}²β²=0 and one obtains x≈I_{O}·β² (3) (in neglecting the terms of the order, higher than 2) making the root approximation (Taylor series) with 3 terms.

3. Time Path Difference at Any Observation Point After 90° Rotation (FIG. 1B Configuration).

3.1. ∥ Path OM₂′NE′.

From similar triangles ΔPM₂′N and ΔNEE′: EE′/NE=M₂′P/PN

and (V_{E}t_{II↑}+V_{E}t_{II↓})/(y−2PN)=(I_{O}−V_{E}t_{II↑})/PN,

where the t_{II↑} and t_{II↓}—the times for path OM₂′ and M₂′NE′ correspondingly. After the simple transformations, we get: PN=y·(I_{O}−V_{E}t_{II↑})/(2I_{O}+V_{E}t_{II↓}−V_{E}t_{II↑}).

After the approximation (series Taylor) of the above corrected inverse function with the consecutive multiplication (in neglecting/at the end/the terms of higher/than β²/orders), one gets: PN≈y/2 (4), where the y must be already proportional to I_{O}·β²—§2.3.).

Let find NE′ from the similar triangles ΔPM₂′N and ΔNEE′:
NE′=NM₂′·EE′/M₂′P=OM₂′·(V_{E}t_{II↑}+V_{E}t_{II↓})/(I_{O}−V_{E}t_{II↑}) (where NM₂′=OM₂′).

Analogically to the transformations of PN/in obtaining the equation (4)/, we get:
NE′=(OM₂′/I_{O})·(V_{E}t_{II↑}+V_{E}t_{II↓}+V_{E}²t_{II↑}²/I_{O}+V_{E}²t_{II↑}t_{II↓}/I_{O}) (5)

From right-angled triangle ΔOM₂′P, one has:
OM₂′=√(OP)²+(M₂′P)²=√(PN)²+(I_{O}−V_{E}t_{II↑})².

With simple calculations (analogically to §7.3.2.1.) in dividing by I_{O}, approximating the root (Taylor series: taking firstly until the term of second order) and in neglecting (at the end) the terms of higher (than β²) orders, we obtain (after dividing by c):
t_{II↑}(OM₂′)=(I_{O}/c)(1−V_{E}t_{II↑}/I_{O}+(PN)²/2I_{O}²).
   Using equation (4), one has: t_{II↑}=I_{O}/c−V_{E}t_{II↑}/c+y²/8I_{O}c (6),
   hence one can find t_{II↑}: t_{II↑}=(8I_{O}c+y²)/(8I_{O}c+8I_{O}V_{E})
   and then after approximation (series Taylor) of the above corrected (division and multiplication by 8I_{O}c) inverse function with consecutive multiplication (neglecting the higher terms) (analogically to the, justly, above), we get:
   t_{II↑}=I_{O}/c−I_{O}·β/c+I_{O}·β²/c+y²/8I_{O}c (7)

From equation (5), one has the time for NE′ light path:
t_{NE′↓}=(t_{II↑}/I_{O})·(V_{E}t_{II↑}+V_{E}t_{II↓}+V_{E}²t_{II↑}²/I_{O}+V_{E}²t_{II↑}t_{II↓}/I_{O}).

This equation permits to calculate the time for M₂′NE′ path: /t_{II↓}(M₂′NE′)=t_{II↑}+t_{NE′}/, where analogically to obtaining the equation (7) from (6), one gets the expression for t_{II↓}with approximation of inverse function, multiplications and simple transformations:
t_{II↓}=t_{II↑}+2t_{II↑}²V_{E}/I_{O}+3t_{II↑}³V_{E}²/I_{O}².

So t_{II} (total)=t_{II↑}+t_{II↓}=2t_{II↑}+2t_{II↑}²V_{E}/I_{O}+3t_{II↑}³V_{E}²/I_{O}² and using the equation (7), taking even one term from t_{II↑}³, making the simple transformations and neglecting the terms of higher orders, we get:
t_{II} (total)≈2I_{O}/c+y²/4I_{O}c (8).

3.2. ⊥ Path OM₁E′.

With help of the right angled triangles ΔOM₁R and ΔHM₁E′, one has: (OM₁)²=c²t_{⊥→}²(OM₁)=(RM₁)²+(OR)²=I_{O}²+V_{E}²t_{II↑}², hence, analogically to 3.1., simply, t_{⊥→}≈(I_{O}/c)(1+β²/2), using the equation (7).

Also: (M₁E′)²=c²t_{⊥←}²(M₁E′)=(M₁H)²+(HE′)²=(I_{O}−y)²+(V_{E}t_{II↓})²t_{II↓}t_{II} (total)−t_{II↑}=I_{O}/c+y²/8I_{O}c+I_{O}β/c−I_{O}β²/c with equations (8) and (7). And t_{⊥←}=(1/c)√(I_{O}−y)²+V_{E}²(I_{O}/c+y²/8I_{O}c+I_{O}·β/c·I_{O}·β²/c)²≈(I_{O}/c)(1+β²/2−y/I_{O}) neglecting the terms of the order, higher than 2 (in taking the 3 terms at the root approximation). Consequently t_{⊥}(total)=t_{⊥→}+t_{⊥←}=2I_{O}(1+β²/2)/c−y/c (9).

3.3. So t_{II} (Total) Increases With y and t_{⊥} Decreases With y.

Let us find the y value when their difference is zero/Δ(t_{⊥}−t_{II})=0/:

Easily with equations (8) and (9), we get the second order equation for y:

Hence: y²+4I_{O}y−4I_{O}²β²=0 (10) and y=I_{O}·β² coinciding perfectly with similar calculations for FIG. 1A, confirming well the validity of these long calculations.

Supplement 2. Proofs of Fundamentally Erroneous Applications of Very Short Light Pulses (§5) in Time-Resolved Relaxation Spectroscopy (Apriori False, in Spite of Hundreds of Works Per Year).

Here I profoundly show that these revolutionary short light pulses (§5) cannot work for spread time-resolved spectroscopy field (that is absolutely unknown with hundreds of works per year (!!) as artefacts. Such profound honest development shows the perfectness of (too efficace) rest.

A. Perfect Data Experimental Constradictions.

Yet in 1973, the profound specialist of time-resolved spectroscopy decay I. Isenberg wrote modestly about his own method that there is “a number of SIGNIFICANT nonrandom errors in fluorescence time decay” [151]. Historically, the good veritability of young time-resolved spectroscopy method was shown in several serious pioneering works with very close agreement between time-resolved and phase SHIFT lifetime measurements of numerous dyes in nonviscous solutions [152,153], where the classical sole exponential decay was always seen [152-157].

But already at higher polarizations, in spite of “excellent agreement” with steady state etalon method (executed by different countries equipment) for lifetimes of the excited states (with classical one exponential decays) for dyes in nonviscous solutions, the nonexponential decays were found only with proteins wherein “the decay times for proteins vary considerably but in most cases as long or longer than for free triptophane even though it is known that the quantum yield of the triptophane fluorescence in often below than that of the free triptophane” [158] and consequently the later lifetimes must be certainly lower (very objective judgment against own results however). But for conjugates of immunoglobulin G with dansyl (wavelength maximum λ=540-545 nm) there was no heterogeneity according to sensitive fluorescence characteristics (quantum yield and polarization) until the value of the dye/protein equal to 6 [159] as one should also wait for globular proteins without very special binding sites (as for albumins). Moreover, there was the “appearance of nonexponential fluorescence decay in more viscous solutions” for dyes, whereas such decay in water and n-butanol was exponential [160]. Again, the same author obtained, for conjugates of bovine serum albumin with dansyl (at dye/protein ratio=2-3 and λ=500 nm), the lifetime values near 21 nsec [161] that was already much higher than those obtained by phase method in classical work (value of 12 nsec) [162]. Did it already signify that there was wrong measured increase of lifetimes at higher fluorescence polarization?

The clear analysis of data in viscous medium permits to confirm strongly the unlikelihood of the time-resolved data in such conditions of higher polarizations. Indeed, justly, in viscous medium as liposomes and all cell membranes there is well established (by time-resolved method) residual (for infinite time) anisotropy [163] for small dye molecules DPH (1,6-diphenyl-1,3,5-hexatrien), confirming the above thesis. The restricted DPH orientation freedom in isotropic (as whole) membrane vesicle and liposome systems (“orentation order”) [163] is a little probable. But moreover, one can already state that such restriction has no real sense because numerous publications with “very sensitive and reproducible” measurements with steady state basic fluorescence polarization established that the Perrin equation is valid (dependence curve is “close to stright line”) for all series of liposomes and membranes for large diapason of variation of ratio of temperature to viscosity [164]. One can easily estimate that the rapidest relaxation time of dye (with maximal ratio of temperature to viscosity) clearly permits the whole depolarization/supposed as the revolting of mean anisotropy vector at chosen angle α (cos α=1/e)/, with mean observation time equal to lifetime of excited state. So de facto, there is no any restricted dye orientation and the established artefacts of time resolved fluorescence method at higher polarizations are shown de facto. Evidently, in control measurements, one must have the residual anisotropy with all dyes with high lifetimes in cold viscous solutions (as glycerol or sucrose). Such residual anisotropy appears already to see in ANS-glycerol solution at 4° C. [165].

Analogically, at higher polarizations, especially at larder macromolecules, such time-resolved method gives the high polarization values with higher errors. For instance, for myosin rod fragment S1 (molecular weight 130 kDa), the value of rotational correlation time was equal ˜240 nsec (several Refs. in [166]). But the simple calculations for classical rigid model of rod prolate ellipsoid with axis ratio 1:4 [166], classical partial specific volume 0.73 cm³/g, and hydration 0.3 g/g [167,168] and with sole accessible and (correctly published in plot) universal relation of correlation times for rigid prolate ellipsoid and sphere (1.52) [169] gives only 74 nsec (25° C.). Naturally, one accepts the measured random nonspecific dye orientations [162]. Although at profound consideration of basic conditions of the rotational ellipsoid approximation of the polypeptide wire, one shoud realize that in this case, the ellipsoid axes are only effective ones to satisfy mathematically the motion equations and in such wire there is no (and cannot be) the fixed (in space) main axes. So at such moment, the directions of such axes change, depending on current Brownian knocks. Consequently, with such obligatory spectrum of main axes directions for long polypeptide wire, the oscillator orientation factor will be strongly damned. It must mean that the value of established artefact is more than 300%! (not some 20%, but 300%). Evidently, one must approximate normal “globular” proteins as (de facto [169]) only the rod prolate ellipsoids, also, because they are “assembled from modules” [169a] (one to another) and cannot be assembled (de facto also) as flat discs. Normally, the sedimentation coefficient and molecular weight of macromolecules (with classical hydrations) undoubtly determine already uniquely the axis ratio (like 1:4) as confirmed with effective validity of “hydrodynamically effective (as rigid molecule) volume” [170,171] for macromolecules. Evidently mean polarization (measured by classical way) is very different from wrong mean polarization calculated from decay curve.

B. Degree of Afterpulse Activation Process (Physical Decreases With Time of “Space Charge Buildup”) Depends on Time of Arrival of Next Signal: Perfect Origin of Nonproportionality Artefacts.

Let us see the proprieties of registering photomultiplier tubes (PMT). There are the afterpulses that represent the succeeding (main signal) spurious pulses due to different, not well understood, ionic effects [172,173] that often arise at approx. 15 and 250 nsec after main pulse [172-174]. The afterpulses can have rather large amplitudes [173] and “serious distortions may occur in the reconvolution analysis used to retrieve fluorescence lifetime data” [172]. “The afterpulses may produce one or more subsequent afterpulses with probability of each being different depending on number of electrons involved” [175]. Especially with single photon avalanche diodes in PMT [174], it must mean that the afterpulses (including such afterpulses appearing at the longer time after main signal) have clearly nonlinear properties (higher than proportional increase with light intensity). So there is the superposition of the afterpulses of preceeding pulses [174].

It signifies that some IONIC processes, helping for later afterpulses, rest yet activated until the arrival of the afterpulse (process) of next signal, that produces the higher afterpulse current and such current will be dependent on the frequency of the falling light, it means (at single-photon technique) on the light intensity additionally, with nonlinear dependence where de facto, justly the “intensity of light source” changed “the intensity of F_{Y}(t)/horizontal composant/relative to that of F_{Z}(t) vertical composant/” [168]. So, the artificial nonequivalent addition is always present, because the F_{Z} composant is apriori stronger that F_{Y}, that is well developping at high polarizations, justly making the artefact unavoidable. The above ionic interpretation is confirmed by independent data. “Some space charge buildup can occur within a few (or plus) nsec” [176,177]. “Significant background illumination” “can induce a sizeable afterpulse rate” for “short light flashes” [173]. So additional lasting fluorescence (in self-triggering conditions) does not produce the same afterpulses as pure source light used for convolution and naturally, “even when PMTs of the same type are used in identical conditions they give different afterpulsing” [173] and “results were dependent (also) on frequency of laser pulses” [176] that also influences such variable charge buildup.

C. Physical Properties of Afterpulse PMT Currents Clearly Explain Time-Resolved Method Falseness at Higher Polarizations.

Justly, the above ionic artefacts at nanosecond scale due to the measuring PMT, permit to explain strange data of time resolved fluorescence at the higher polarizations (section A). Evidently, justly as mentioned, at higher polarizations, the intensity of vertical component is becoming more and more strong relatively the horizontal one. Because, of nonlinear nonnegligible afterpulse currents, depending on light intensity due to the understood generally physical process (section B), the measured polarization [proportional to F_{Z}(t)−F_{Y}(t)], with increasing of its real value (larger macromolecules or larger viscosity), will have higher artificial additions to the real value, especially at the longer observation times (later afterpulses) according to the understood generally physical process (section B). This was confirmed: by clear fact that “intensity of F_{Y}(t) relative to that of F_{Z}(t) was (unpredictably—Y.Z.) influenced by changes in the intensity of the light source” [168], that, of course, cannot be recalculated only by measurement of the coefficient of instrument current for the same quantity of light for both polarizations. Justly at larger macromolecules (as well at larger viscosities), the difference with real values will be higher, especially at longer time regions of afterpulse appearances (for instance towards 250 nsec) (section A). Moreover, justly essentially lower “values of 0.2 (for anisotropy) are often encountered” [168], that justly confirms higher values of additional later currents (afterpulses, for instance, at regions of 250 nsec) at longer times after excitation pulse and, evidently, naturally wrong approximations to zero time value, especially with lasting fluorescence. As consequence, one cannot utilize even the most short pulses (§5) for such time-resolved methods using PMT generally!

### REFERENCES

[1] Laloë, F. Am. J. Phys. 69, 655-701, 2001.
[2] Zagyansky, Y. International Patent Publication No WO 99/56288 (04 Nov. 1999!) and WO 00/52989 (14 Sep. 2000) “Einstein-Bohr End: New atomic scale Physics, Electric field: neutrinos and electrons in conversions, perpetual motion, development: seisms, extinguished volcans, created islands, Big Bang Energy. Practical consequences”—full text in: http://pctgazette.wipo.int. Exemplary International Search Report in PCT Gazette April 2001.
[3] Zagyansky, Y. “Global Triumphant physics after Einstein-Bohr End: different succeding Big Bangs switching of Galaxies, cosmic rays more rapid than light and noninteracting. Practical consequences”. Applications PCT/FR02/01308, PCT/FR02/02583, PCT/FR02/02709 (all retired with Form PCT/IB/301). This Application is exact combination of these Applications.
[4] Zagyansky, Y. “Absolute End of Einstein's Theory of Relativity: Utopy of Michelson's Measurements and new interferometer consequnces” French Application No 2825796 (2002).
[5] Chapman, A. J. “Heat Transfer” 3d Ed. McMillan Publ. London (1974).
[6] Thorne, K. S. “Black Holes & Time Warps. Einstein's outrageous legacy” W.W. Norton, N.Y. (1994).
[7] Hachi, A. La Recherche No 360, pp. 52-55, 2003.
[8] Lammerzahl, C., Braxmaier, C., Ditus, H., Muller, H., Peters, A. & Schiller, S. Int. J. Mod. Phys. 11, 1109-1136,2002,
[9] Muller, H., Braxmaier, C., Hermann, S., Mlynek, J., Schiller, S. & Peters, A. Proceedings of 2002 Conference of Precision Electro magnetic measurement (cat No 02CH37279), pp. 512-513 (2002).
[10] Su, C-C. Europhys. Lett. 56, 170-174, 2001.
[11] Combes, F., Boissé, P., Mazure, A. Blanchard, A. “Astrophysics. Galaxies and Cosmology” Ed. CNRS, Meudon (1991).
[12] De Brogli, L. “Critic Essay about bases of actual interpretation of Wave Mechanics” Gauter-Villars & Cir, Paris (1963).
[13]. Vigué, J. La Recherche No 349, pp. 18-19, 2002.
[14] Barrett, R. C. & Jackson D. F. “Nuclear size and structure”, Clarendon Press, Oxford (1977).
[15] Bohm, D. “Causality and chance in modern physics” Routledge & Kegan Paul, London (1967).
[16] Herzberg, G. “Atomic spectra and Atomic Structure”, Dover Publications, N.Y. (1944).
[17] Stryer, D. F., Balkin, M. S., Becker, K. M., Burns, M. R., Dudley, C. E., Gaumer, J. S., Kramer, M. A., Oertel, D. C., Park, L. H., Rinkoski, M. T., Smith, C. T. & Wotherspoon, T. D. Am. J. Phys. 70, 288-297, 2002.
[18] Prizibram, K. “Letters on wave mechanics” Philosophical Library, N.Y. (1967).
[19] Schrodinger, E. “Essays on the Wave Mechanics”, Jacques Gabay, Sceaux (1988).
[20] Payen de Caranderie, H. “Quantum Mechanics”, Masson, Paris (1971).
[21] Simon, B. J. Math. Phys. 41, 3523-3555,2000.
[22] Born, M. “Atomic structure of matter”, Armand Colin, Paris (1971).
[23] Einstein, A., Podoisky, B. & Rosen, N. Phys. Rev. 47, 777-780,1935.
[24] Bell, J. S., Physics (Long Island City, N.Y.) 1, 195-200,1964.
[25] Bell, J. S. Rev. Mod. phys. 38, 447-452,1966.
[26] Kochen, S. & Specker, E. P. J. Math. Mech. 17, 59-87,1967.
[27] Hartle, J. B. Int. J. Mod. Phys. A 16, 1-16, 2001.
[28] Dewitt, B. Int. J. Mod. Phys. A 13, 1881-1916, 1998.
[28a] Zagyansky, Y. “New fundamental chapters of Cellular and Intercellular Molecular Biology in 2050 (with top medical applications)” ISBN: 2-9502914-8-1, Paris, 1995. Very detailed Summary in “Lancet” (London) vol. 346, No 8986 (18 Nov. 1995), p. Classified 2, No D710 (PCT/FR94/1159).
[29] Baruch, J.-O. La Recherche N° 361, 34-38, 2003. Perlmutter, S. Phys. Today 56, No 4, 53-60, 2003!
[30] Nagano, M. & Watson, A. A. Rev. Mod. Phys. 72, 689-732, 2000.
[31] Davies, P. “The New Physics”, Flammarion, Paris, 1995 and Cambridge Univ. Press, 1993.
[32] McGrow-Hill Encyclopedia of Science and Technology 19 vols, 8th Ed. McGrow Hill, N.Y., 1997.
[33] Quinn, H. R. Phys. Today 56, No 2, 31-35,2003.
[34] Jungman, G., KamionKowski, M. & Griest, K. Phys. Rep. 267, 195-373,1996.
[35] Anderson, P. Nucl. Phys. B (Proc. Suppl.) 85, 201-206, 2000.
[36] Faget, P. La Recherche No 338, pp. 29-31, 2001.
[37] Jolie, J. Sc. Am. 286, No 7, pp. 54-61, 2002.
[38] Colas, P. & Tuchming, B. La Recherche No 364, pp. 30-36, May 2003.
[39] Compagno, G., Passante, R., Persico, F. & Salamone, G. M. Acta Phys. Pol. A 85, 667-676, 1994.
[40] Bernard, V., Kaiser, N., Lee, T.-S. & Meibner, U.-G. Phys. Rep. 246, 315-363,1994.
[41] The HERMES Collaboration, Eur. Phys. J. C 21, 599-611, 2001.
[42] Nagl, A., Devanathan, V. & Uberall, H. Springer Tracts Mod. Phys. 120, R5-R149, 1991.
[43] Rho, M. Annu. Rev. Nucl. Part. Sci. 34, 531-582,1984.
[44] Ashery, D. & Schiffer, J. P. Annu. Rev. Nucl. Part. Sci. 36, 207-252,1986.
[45] Lee, T.-S. H. & Redwine, R. P. Annu. Rev. Nucl. Part. Sci. 52, 23-63, 2002.
[46] Johnson, M. B. & Morris, C. L. Annu. Rev. Nucl. Part. Sci. 43, 165-208,1993.
[47] Drechsel, D. & Tiator, L. J. Phys. G 18, 449-497, 1992.
[48] Segré, E. “Nuclei and Particles”, 2nd Ed. W.A. Benjamin, London, 1977; Bayron, P. “Particle Physics at the new Millennium” Springer-Verlag, N.Y., 1996; Zitoun, R. “Introduction Into Particle. Physics”, Dunod, Paris, 2000.
[49] Scholten, O. & Korchin, A. Yu. Phys. Rev. C 65, 054004-1, 2002.
[50] Prakash, M., Lattimer, J. M., Sawyer, R. F. & Volkas, R. Annu. Rev. Nucl. Part. Sci. 51, 295-344, 2001.
[51] Dolgov, A. D. Phys. Rep. 370, 333-535, 2002.
[52] Barger, V., Philips, R. J. N. & Sarkar, S. Phys. Lett. B 352, 365-370, 1995.
[53] Govaerts, J., Deutsch, J. & Van Hove, P. M. Phys. Lett. B 389, 700-706, 1996.
[54] Gninenko, S. N. & Krasnikov, N. V. Phys. Lett. B 450, 165-172, 1999.
[55] Fisher, P., Kayser, B. & McFarland, K. S. Annu. Rev. Nucl. Part. Sci. 49, 481-527,1999.
[56] Gaisser, T. K. & Honda, M. Annu. Rev. Rev. Nucl. Sci. 52, 153-199, 2002.
[57] Jung, C. K., Kajita, T., Mann, T. & McGrew, C. Annu. Rev. Nucl. Part. Sci. 51, 451-488, 2001.
[58] Kajita, T. à Totsuka, Y. Rev. Mod. Phys. 73, 85-118, 2001.
[59] Hansen, S. H., Lesgourgues, J., Pastor, S. & Silk, J. Mon. Not R. Astron. Soc. (UK) 833, 544-546, 2002.
[60] Barshay, S. & Kreyerhoff, G: Phys. Lett. B 535, 201-206, 2002; Nuov. Cim. A 112, 1463-1468, 1999.
[61] Barger, V., Halzen, F., Hooper, D. & Kao, C. Phys. Rev. D. 65, 075022-26, 2002.
[62] Zhukovskii, V. Ch, Grigoruk, A. E., Levchenko, K. G. & Eminov, P. A. Vestn. Mosk. Univ. 3Fiz, Astron (Russia) No 5, 62-63, 1997.
[63] Feng, J. L., Gunlon, J. F. & Han, T. Phys. Rev. D 58, 071701-7,1998.
[64] Volkas, R. R. Progr. Part. Nucl. Phys. (UK) 48, 161-174, 2002.
[65] Perkins, W. A. Int. J. Mod. Phys. A 16, 919-921, 2001.
[66] Kopeikin, S. & Fomalont, E. Phys. Today 56, No 3, pp. 9-9, 2003.
[67] Schaeffer, I R. La Recherche No 338, p. 25-29, 2001.
[68] Henry, R. C. Annu. Rev. Astron. Astrophys. 29, 89-127, 1991.
[69] Wilkinson, D. T. 1st ESO-CERN Symposium on large scale structure of the Universe, Cosmology and Fundamental Physics. Proceedings. CERN, Geneva, 1984, pp. 153-166.
[70] KamionKowski, M. Jr. & Kosowsky, A. Annu. Rev. Nucl. Part. Sci. 49, 77-123, 1999.
[71] Sreekumar, P. et al Astrophy. J. 494, 523-534, 1998.
[72] Henry, R. C. Astrophys. J. 516, L49-L52, 1999.
[73] Loeb, A. & Waxman, E. Nature 405, 156-158,2000.
[74] Zeilik, M. “Conceptional Astronomy”, Willey & Sons, N.Y., 1993 p. 399.
[75] Hasinger, G. “X-ray background: echo of black hole formation”, Astrophys. Inst. Potsdam, 1999, pp. 1-10.
[76] Severgnini, P. et al Astron. Astrophys. 360, 457-462, 2000.
[77] Sasaki, S. & Umemura, M. Astrophys. J. 462, 104-109,1996.
[78] Gawiser, E. & Silk, J. Phys. Rep. 333-334, 245-276, 2000.
[79] Silk, J. Astrophys. lett. commun. 37, 315-320, 2000.
[80] Peebles, P. J. E. “Principles of Physical Cosmology”, Princeton Univ. Press, N.J. 1993, pp. 131-134.
[81] Opher, M. & Opher, R. Phys. Rev. Lett. 79, 2628-2631, 1997.
[82] Partridge, R. B. Class. Quant. Grav. 11, A153-A169, 1994.
[83] Virbhadra, K. S. & Ellis, G. F. R. Phys. Rev. D 62, 08400311-8, 2000; Bartelman, M. & Schneider, P. Phys. Rep. 340, 291-472, 2001.
[84] Lano, R. P. Astrophys. Space Sci. 159, 125-132,1989.
[85] Paczynski, B. Nature 321, 419-420, 1986.
[86] Maccone, C. Acta Astron. 46, 605-614, 2000.
[87] Davies, R. D. Astrophys. Left. Commun. 37, 349-358, 2000.
[88] Schamm, D. N. & Steigman, G. Gen. Rel. Grav. 3, 101-107,1981.
[89] Novikov, I. D. & Sharov, A. “Hubbe—Big Bang inventor”, Flammarion, Paris, 1995, p. 258.
[90] Menten, K. M., Caril, C. L. & Reid, M. J. Astron. Soc. Pac. Conf. Ser. 156, 218-227, 1999.
[91] White, M. & Scott, D. Astrophys. J. 459, 415-431, 1996.
[92] Eppey, J. M. & Partridge, R. B. Astrophys. J. 538, 489-492, 2000.
[93] Davis, M. Phys. Rep. 333, 147-165, 2000.
[94] Bahcall, N. A. Phys. Rep. 333, 233-244, 2000.
[95] Turner, M. S. Phys. Rep. 333, 619-635, 2000.
[96] Vangioni-Flam, E., Casse, M. & Audouze, J. Phys. Rep. 333, 365-387, 2000.
[97] Pagel, B. E. J. Phys. Rep. 333, 433-448, 2000.
[98] Tytier, D., O'Meara, J. M., Suzuki, N. & Lubin, D. Phys. Rep. 333, 409-432, 2000.
[99] Hobbs, L. M. Phys. Rep. 333, 449-469, 2000.
[100] Olive, K. A., Seligman, G. & Walker, T. P. Phys. Rep. 333, 389-407, 2000.
[101] Vagnioni-Fram, E. (in Slezak, E. & Thévenin, F. Ed. “Evolution des élements légers”), Cepadues-Editions, Toulouse, 1998, pp. 109-130.
[102] Cassé, M. (in Slezak, E. & Thévenin, F. Ed. “Evolution des élements légers”), Cepadués-Editions, Toulousde, 1998, pp. 97-108.
[103] Novikov, I. D. (in Münch, G., Mapaso, A. & Sànchez, F. Ed. “Universe at large”) Cambridge Univ. Press, 1997, pp. 269-310.
[104] Carrol, B. W. & Ostlic, D. A. “An introduction to Modern Astrophysics”, Addison-Wesley, Mass., 1996; Zeilik, M. “Astronomy. The evolving Universe”, 9th Ed., Cambridge Univ. Press, 2002; Padmanabhan, T. “Theoretical Astrophysics” vol.3, Cambride Univ. Press, 2002.
[105] Bertin, G. “Dynamics of Galaxies”, Cambridge Univ. Press, 1999.
[106] Griest, K. & Kamion-Kowski, M. Phys. Rep. 333, 167-182, 2000.
[107] Benest, D. & Froeschlé, C. Ed. “L'Univers des Galaxies”, Hachette, Paris, 1995.
[108] Melia, F. & Faicke, H. Annu. Rev. Astron. Astrophys. 39, 309-352, 2001.
[109] Barnes, J. E. & Hernquist, L. Annu. Rev. Astron. Astrophys. 30, 705-742,1992.
[110] “Encyclopedia of Astronomy and Astrophysics”, 4 volumes, IOP Publishing Ltd., L. 2001.
[111] Smart, W. W. “Stellar dynamics”, Cambridge Univ. Press, 1938.
[112] Mulder, P. S. Astron. Astrophys. 303, 57-74, 1995.
[113] Mulder, P. S. & Combes, F. Astron. Astrophys. 313, 723-732, 1996.
[114] Rowan, L. & Coontz, R. Science 299, 59-59, 2003.
[115] Wakker, B. P. & Van Woerden, H. Annu. Rev. Astron. Astrophys. 35, 217-266,1997.
[116] Meynet, G. in (Slezak, E. & Thévenin, F. Eds. “Evolution des elements légers”), Cepadués-Editions, Toulouse, 1998, pp. 204-264.
[117] Lamb, D. Q. Phys. Rep. 333-334, 505-528, 2000.
[118] Burrow, A. & Young, T. Phys. Rep. 333-334, 63-75, 2000.
[119] Germany, L. M. et al Astrophys. J. 533, 320-328, 2000.
[120] Lazatti, D. et al Astrophys. J. 529, L17-L20, 2000.
[121] Brown, G. M. et al Phys. Rep. 333-334, 471-504,2000.
[122] Piran, T. Phys. Rep. 333-334, 529-553, 2000.
[123] Olinto, A. V. Phys. Rep. 333-334, 329-348, 2000.
[124] Amenomori, M. et al Phys. Rev. D 47, 2675-2681,1993.
[125] Potgleter, M. S. Geophys. Res. 105, 18295-18303, 2000.
[126] Amenomori, M. et al Adv. Space Res. 23, 611-615, 2000.
[127] Ambrosio, M. et al Phys. Rev. D 59, 012003/1, 1999.
[128] Kearns, E., Kajita, T. & Totsuka, Y. Sci. Am., 281, No 2, 48-55,1999.
[129] Pomarede, D. et al Astropart. Phys. 14, 287-317, 2001.
[130] Rosenberg, L. J. “Vancuver Meeting. Particles and Fields 91”, p. 1008-1008, 1992.
[131] Amenomori, M. et al Astrophys. J. 464, 954-966,1996.
[132] Amenomori, M. et al AIP Conf. Proc. 557, 2001.
[133] Amenomori, M. et al Astrophys. J. 541, 1051-1058, 2000.
[134] Cobb, J. H. et al Phys. Rev. D 61, 2002-2007; 2000.
[135] Borione, A. et al Phys. Rev. D. 49, 1171-1177,1994.
[136] Hornyak, W. F. “Nuclear Structure”, Acad. Press., N.Y., 1975.
[137] Van Nostrand's Scientific Encyclopedia, 6th Ed. Condidine, D. M. & Consedine, G. D. Eds., Van Norstrand Reinold Company, N.Y., 1983, p. 798.
[138] Biermann, P. L. in HIRSCHEGG 98. Nuclear Astrophysics. Proceedings of the International Workshop XXVI on Gross Proprieties of Nuclei and Nuclear Excitations, 1998, p. 211.
[139] Warnecke, R. R. “Introduction à l'etude des accélérateurs de particles: physique atomique, physique nucléaire, physique des hautes énergies à l'usage des ingénieurs”, Paris, Masson, 1975-1976, vol.1 and 2, pp. 1-1633.
[140] Wiedemann, H. “Partcle Accelerator Physics, 2nd Ed, Springer, Berlin, 1999; Reiser, M. “Theory and design of charged particle beams”, Willey & Sons, N.Y., 1994; Schopper, H. F. Ed. “Advances in Accelerator Physics and Technology”, 1993.
[141] Goldsmith, M. & Shaw, E. “Europe's geant accelerator: Story of CERN 400 GeV proton, synchrotron”, Taylor and Francis, L., 1977; Boussard, D. “Les accelerators de particles”, PUF, Paris, 1984.
[142] Bromley, D. A. “Large electrostatic accelerators”, Amsterdam, 1974.
[143] Desanto, A. Intern. J. Mod. Phys. A 16, 4085-4151, 2001.
[144] Palmer, R. B. Annu. Rev. Nucl. Part. Sci. 40, 529-592,1990.
[145] Lerner, R. G. & Trigg, G. L. “Encyclopedia of Physics” 2nd Ed., VCH Publishers, 1991, pp. 956-960.
[146] Ikegami, H. Int. J. Quant. Chem. 71, 83-99, 1999.
[147] Ikegami, H. Phys. Rev. Lett. 60, 929-936,1988.
[148] Michelson, A. & Morley, E. W. Am. J. Sci. 34, 333, 1887.
[149] Shankland, R. S. Rev. Modern Phys. 27, 167, 1955.
[150] Miller, D. C. Rev. Modern. Phys. 5, 203, 1933.
[151] Isenberg, I. J. Chem. Phys. 59, 5696, 1973.
[152] Ware, W. R. & Norvas, J. S. J. Phys. Chem. 70, 3246, 1966.
[153] Ware, W. R. & Baldwin, B. A. J. Chem. Phys. 40, 1703, 1964.
[154] Hallidi, L. A. & Topp, M. A. J. Phys. Chem. 82, 2415, 1978.
[155] Fleming, G. R., Morris, J. M. & Robinson, G. W. Chem. Phys. 17, 91, 1976.
[156] Li, Y. H. et al J. Am. Chem. Soc. 97, 3118, 1975.
[157] Tan, X. & Gustafson, T. L. J. Phys. Chem. A 104, 4469, 2000.
[158] Chen, R. F., Varek, G. G. & Alexander, N. Science 156, 949, 1967.
[159] Chen, R. F. Arch. Biochem. Biophys. 133, 263, 1969.
[160] Maiti, N. C. et al Phys. Chem. B 101, 11051, 1997.
[161] Chen, R. F. Arch. Biochem. Biophys. 128, 163, 1968.
[162] Steiner, R. F. & McAlister, A. J. J. Polymer. Sci. 24, 105, 1957.
[163] Van der Meer, V. et al Biophys. J. 46, 515, 1984.
[164] Shinitzky, M. & Barenholz, Y. Biochim. Biophys. Acta 515, 367, 1978.
[165] Yguerabide, J. & Fortes, P. A. G. (unpublished), cited from [168].
[166] Dale, R. E. et al Biophys. J. 76, 1606, 1999.
[167] Cantor, C. R. & Schimmel, P. R. Biophysical Chemistry, W.H. Freeman, San Franc., 1980.
[168] Yguerabide, J. Meth. Enzymol. 26, 498, 1972.
[169] Weber, G. Adv. Prot. Chem. 8, 415, 1953.
[169a] Branden, C. & Tooze, J. “Introduction to protein structure”, De Boeck, Bruxelles, 1996.
[170] Scheraga, H. A. & Mandelkem, L. J. J. Am. Chem. Soc. 75, 179, 1953.
[171] Small, E. W. & Isenberg, I. Biopolymers 16, 1907, 1977.
[172] Hungerford, G. & Birch, D. J. S. Meas. Sci. Technol. 7, 121, 1966.
[173] Mirzoyan, R. et al Nucl. Instr. Meth. Phys. Res. 74, 387, 1997.
[174] Hobel, M. & Riska, J. Rev. Sci. Instr. 65, 2326, 1994.
[175] Campbell, L. Rev. Sci. Instr. 63, 5794, 1992.
[176] Hart, L. P. & Daniels, M. Appl. Spectrosc. 46, 191, 1992.
[177] Boulot, J. P. Adv. Electron. Phys. 60, 223, 1983.

Legends to Figure.

FIG. 1. The precise geometry of the Michelson-Morley-Miller experiments. The scales of the light displacements are arbitrary for a convenience. V_{E}—absolute Earth velocity, c—light velocity value. β=V_{E}/c. Length (I_{O}) of the “shoulder” OM₁=32m, S—light source, M_{2I} and M_{1I}—virtual images of the light source in M₂; M_{2I}I and M_{1I}I are the distances to any point I at the observable line OM′ in the creation of the interference pattern with help of M_{1I} and M_{2I}; AM_{2I}—interferential path difference; G—semi-transparent glass plate; T—observing telescope; M₁ and M₂—mirrors. A. OM₂O′—total light path in perpendicular (⊥) to the V_{E} direction, wherein the light “meets”, at the displaced O observation point (becoming point O′ due to Earth movement), the beam separation point, the parallel beam. M′₁—new mirror position after Earth displacement (OM′₁—light trajectory). Such M′₁ site is varied at light arrival to fixed point M₂ or ANY point M but for commodity, I do not draw 2nd site of M₁ and calculations are the same anyway. OM′₁O′—total light path in parallel (∥) direction until the same point O′. E—is arbitrary observation point (at distance x of order of ˜I_{O}β from O′). OM′₂E and OM′₁E are the total ⊥ and ∥ light paths until point E. OM₂=M₂O′, OM′₂=M′₂E, M₂P′⊥OM₁ and M′₂P″⊥OM₁. B. Device position after its rotation counter-clockwise, through 90°. M′₂—new M₂—position due to Earth movement. Observation of any point E′/distance y from O (order ˜I_{O}β, in reality order ˜I_{O}β² as the x-value—3.2.)/. OM′₂NE′—total light path in parallel direction (OM′₂=M′₂N). M′₂P is perpendicular. OM₁E′—path in the ⊥ direction. EE′⊥OE. (E)H and H(E′)—positions of E at the moment when the light arrives to M′₂ and E′ (due to Earth movement).

Note, that V_{E}: t_{∥}˜V_{E}: t_{⊥}˜V_{E}: I_{O}/c˜I_{O}β.

Important Supplement for Search: According to Law.

According to Art. 52 (2,3) EPC, “discoveries, scientific theories and mathematical methods” are patented when application “relates to such subject matter” as not as such. And directly according to PCT Applicant's Guide, vol. I (Annexes D, E): EPO (European Patent Office) (as International Search Autority—ISA) makes the Search “of all subject matter which is searched under the European patent grant procedure”. Justly EPO (as ISA!) correctly made (according to the above law) the very exemplary Search for Application No PCT/IB00/00843 (PCT Gazette April 2001) that is fundamental for present Application. In confirming: such patents were granted for thousands! best world patents with mathematical methods “not as such” but with their applications. And as examples, I display here 14 too “openly impertinent” “theoretical” examples with complete Searches (in grand majority granted by EPO): 1. EP702866 “Signaling packet for communication system with modulated reference according to a time-base law”; 2. EP467239 “An encryption system based on Chaos theory”; 3. EP873499 “Five colour theory”; 4. EP 784267 “An efficient data-driven theory revision system”; 5. EP523544 “Calculating equipment for solving system of linear equations”; 6. “A method of generating partial differential equations for stimulation method, and a method of generating stimulation programs”; 7. EP 392287 “Fourier transform engine using number theoretical transforms”; 8. EP314809 “Vector processor for processing recurrent equations”; 9. EP 421092 “Method and apparatus for performing mathematical functions using polynomial approximation and a rectangular aspect ratio multiplier”. 10. EP 398830 “Method and apparatus for compressing image data by mathematical transformations”; 11. EP449994 “ . . . using Stiff differential equations”; 12. EP1047181 “New laws for physics”; 13. EP296216 “Organization of theory based systems”; 14. EP218971 “Method for solving of equations of type z=kx1 y1 . . . ”.

Acknowledgement. In such Historical definitive end of Classical Einstein-Bohr Physics, I permit to mention that I had the chance to have the special permission to follow the lectures, practical courses, examinations of chosen best Physics Professors (all personally), only due to whom, I passed all examinations without exceptions as “very excellent”, confirming my 1st Prize in allUnion Physico-Mathematical Olympiad at the end of secondary School. Particularly, I am courteously embedded to Prof. D. P. Kostomarov, Dean in Moscow University today, who (in such unknown to him “epidemic”) personally promoted me (for Mathematical Physics—certainly the most difficult) with only “very excellent” in both year Examinations (including all systematic written practical control exercises) in spite of “astronomical” “nonpassed” even in the best group (75%!).

1. The most Global and General New Bases of Matter of Universe (carefully proven PHYSICS itself!) are characterized by the following characteristics:
1). The electromagnetic waves do not leave the Universe (in expansion today) being collected since “The Creation” of Universe (“Our” Big Bang), that takes place because of multiple complete reflections from its borders, behind which there is no (any more) neutrinos and antineutrinos, propagating the light and changing its velocity;
2). The large spectrum (from radio waves till γ-rays) of strong intensities of the diffuse electromagnetic waves in the Universe of today is due their impossibility to leave the Universe (since Big Bang);
3). Near the elevated masses (as Black Holes or even Sun) there is the presence of augmented concentrations of neutrinos and antineutrinos (having the electron masses), leading to the “gravitational lenses” due to changing of value of the light speed in these conditions (but not because of Utopy of General Theory of Relativity);
4). The mass of Classical Universe is much stronger than Critical one due to very elevated mass of neutrinos and antineutrinos, wherein Universe Contraction will take place, due to gravitational forces after actual Expansion;
5). 2nd Law of Thermodynamics of permanent global increase of entropy is not correct: light cannot leave the Universe and light concentrations must, even, increase at last phases of the Universe contraction;
6). The strong explosion will take place due to very elevated concentrations of electro-magnetic waves during Universe Contraction;
7). In “Our” Big Bang, the explosion provoked only the spallation of the heavy elements and only until hydrogen and helium (and traces of Li—Be—B) and Big Bang (according to Modern Science), described as taking place after particle aggregations or with primordial nucleosynthesis, is profoundly false;
8). Black Holes (constituted of neutros), resting after such Big Bang serve for the Galaxy creation, after rapid currents (that provokes the rotation of stars/luminous matter/around its center) of the luminous matter, well exploded and lighted one sole time, making the disk of the Galactic plane with excentic rotations (of stars) like at Solar System;
9). After future shortage of the heavy elements and growing abundance of the neutro particles after “Our” Big Bang, the Universe contraction (in one of consecutive cycles: explosion of Big Bang and Universe expansion following by Universe contraction and new explosion) must continue without explosion of spallation (weaker) until temperature, when the nuclear reactions (opposed to those of explosion of Supernova stars) of re-utilization already of neutros with neutrinos and antineutrinos (with much stronger explosion) to create electrons, positrons, protons and neutrons, can take place;
10). These cycles of Classical Universe must be permanent (there was the infinity of cycles before us and there will be the infinity after) according to the law of the closing of its borders for the light interacting with the law of Universal Gravitation wherein the cycles with spollation of the heavier elements (weaker explosions) (like “Our” Big Bang) are succeded by those of the nuclear reactions of inversions of titanic explosions of Supernova stars;
11). Titanic cosmic “rays”, produced by Other Universes, justly, must be the products (with diapason of speed values, it means with duration of recording times) of the superpowerful explosions;
12). Such cosmic “rays” (charged ones included) pass easily through the well charged Sun (and cosmic objects as Moon), because of the absence of the mutual electro-magnetic interactions due to their velocities, superior of those of light (it means more rapid than value of fields velocities, that are, in situ, dynamic: being nonpermanent but with strong frequences of the pulses de faco), except the crushing minority of “rays”, that knocks the small nuclei of matter on the trajectory directly;
13). The process of radioactivity characterized in that it is not spontaneous (as it is accepted by all), but it is provoked by the direct knocking of the nuclei of matter by cosmic rays with the value of speed superior of that of light, generally.

2. The consecutive practical process (considering as whole with precise scientific basis of invention) of changing of period of radioactivity (for production of very unstable elements with prices of gold like mendelevium or those with very small periods of lifetime) characterized in that one diminishes/for instance, in putting, very simply, the thick layers of very dense elements (substances) or matter of neutro particles, that are the most dense in Universe/the knocking of nuclei of matter by cosmic “rays” according to claim 1.

3. The process of the creation of extrastrong stable temperatures in “the chamber”, never obtained on Earth, characterized in that one creates the general conditions of Big Bang (in eliminating neutrinos and antineutrinos around the volume [with (already) radiation and high temperature] with help of intensive irradiation of γ-rays and magnetic fields and in diminishing largely this volume) according to claim 1.

4. The process of changing of values of forces and propagation speeds of fields (until values much higher than those of light) in the substance characterized in that the increase of the concentrations of conducting neutrinos and/or antineutrinos (electronic—in the case of electric and “magnetic” fields and muonic—in the case of gravitational one) in this substance (with help of corresponding beams of said neutral particles) changes such characteristics according to claim 1 [leading to the titanic accelerations, permitting interactions of electric and “magnetic” fields with particles having the spead values higher than those of light in accelerators OR the great increase of gravitational masses and interactions (gravitational field)].

5. The process of very great accelerations of particles (in the case of electric and “magnetic” fields) characterized in that one increases the concentrations of conducting electronic neutrinos and/or antineutrinos in directing said electric and “magnetic” fields of accelerators with help of beams of these neutral particles that leads to strong increase of values of force and propagation of these fields according to claim 4.

6. The device to have the beams of neutrinos and/or antineutrinos according to claim 5 characterized in that one places the 2 charged beams (well focusable and dirigible) (preferably saturated) of electrons and positrons in the same direction for their meetings, obtaining, as result, the beams of neutrinos and antineutrinos directly forward (and behind).

7. The new accelerators of claim 5 (firstly synchrotrons) characterized in that they produce also the coherent and polarized radiation (of synchrotron firstly) with (also) the waves shorter than the γ (<1.8×10²¹ Hz), never observed and created before (after creation of positive or negative particle different fluctuations).

8. The utilization of electromagnetic waves with ultra-great frequences of claim 7, characterized in that they help to produce the electric current by new universal means (serving also for all waves, naturally) with the same frequence with help of condensator (in simple electric circuit) having (between its disks) the isolator with slit (or several periodic ones) of the size of half of length of wave (that is coherent and polarized in direction, perpendicular to condensator disks), that guarantees the variable electric current (also strong) of the same frequence, that can directly (in its turn) produce the electromagnetic waves (like in classical transmitter of radio waves) including visible light.

9. The process of destruction of the matter of targets is characterized in that one irradiates them with beams of omnipenetrating particles having overlight speeds that cross the target together with (electronic) neutrino and/or antineutrino beams in destroying the targets due to increase of speed (and force) values of electromagnetic fields in such matter (permitting interactions of these fields with beams of particles with superlight speeds) according to claim 4 [wherein the cosmic “rays” (“ready-to-wear”) can also serve already as omnipenetrating beams of numerous particles with overlight speeds and with colossal energies].
